(19) United States
(12) Patent Application Publication
(10) Pub. No.: US 2025/0038420 A1
(43) Pub. Date: Jan. 30, 2025

(54) WIRELESS SYSTEMS, APPARATUSES, MODULES, AND METHODS USING LEAKY-WAVE ANTENNA ARRAY AS FILTER BANKS FOR BEAM-FORMING AND/OR BEAM-SCANNING

(71) Applicants: Huawei Technologies Canada Co., Ltd., Kanata (CA); LA corporation de I' École Polytechnique de Montréal, Montreal (CA)

(72) Inventors: Dongze Zheng, Montreal (CA); Ke Wu, Montreal (CA)

(21) Appl. No.: 18/897,089

(22) Filed: Sep. 26, 2024

Related U.S. Application Data
(63) Continuation of application No. PCT/CA2022/050514, filed on Apr. 5, 2022.

(51) Int. Cl. H01Q 13/20; H01Q 3/00

(52) U.S. Cl. CPC H01Q 13/20; H01Q 3/005

(57) ABSTRACT

A module has a transmitter (Tx) antenna and a receiver (Rx) antenna. At least one of the Tx and Rx antennas has a leaky-wave antenna (LWA) array for transmitting or receiving one or more signal beams with a range resolution and an angle resolution. The LWA array has a plurality of LWAs configured as a filter bank. By using the filter bank based LWAs, the LWA array may coherently stitch or combine the individual spectrums of the LWAs to have a wide frequency-space coverage for providing improved range and/or angle resolutions.

### CROSS-REFERENCE TO RELATED APPLICATIONS

This application is a continuation of Patent Cooperation Treaty Application Serial No. PCT/CA2022/050514, filed Apr. 5, 2022, the content of which is incorporated herein by reference in its entirety.

### TECHNICAL FIELD

The present disclosure relates generally to wireless systems, apparatuses, modules, and methods, and in particular to wireless systems, apparatuses, modules, and methods using leaky-wave antenna array as filter banks for beam-forming and/or beam-scanning.

### BACKGROUND

For ease of reading, subsection E of the Detailed Description lists the acronyms used in this disclosure.

Radar systems are known. A high-performance radar system is generally preferable or required to detect a plurality of targets over a large field of view (FoV) and estimate the range, angle, and other parametric information of each detected target with sufficient resolution and accuracy. Modern radar systems are required to operate with wideband signal waveforms, such as a linear frequency-modulated pulse (LFM) or a frequency-modulated continuous-wave (FMCW). Moreover, wideband spatial sampling is generally required, meaning that the antenna at the front-end of a modern radar system needs to be capable of providing a wideband and narrow/directive beam (that is, this narrow/directive beam is maintained over the wideband spectrum of the signal waveform) to scan and sample an entire targeted space.

Hitherto, there exist three types of radar systems and related antennas, including:
mechanical beam-scanning system, where the radar system uses a mechanical mechanism such as electro-motors and rotors to rotate a wideband, fixed narrow-beam antenna (for example, a parabolic reflector antenna) for scanning and sampling a targeted space;
multi-beam system (also called “beam-switching” system), where the radar system uses reflector-/lens-based antennas with a cluster of feeders or an array of antennas with beamforming circuits to form a group of wideband, directive beams pointing toward different predetermined angles for scanning and sampling a targeted space; and
phased-array system, where the radar system uses a set of phase shifters, or more often true-time-delay devices for producing a wideband, narrow beam for scanning and sampling a targeted space.

### SUMMARY

According to one aspect of this disclosure, systems, devices, apparatuses, modules, circuitries, and methods are disclosed herein for effectively and efficiently generating wideband beams for scanning and sampling a target frequency-space.

In some embodiments, the system disclosed herein is a filter bank based, LWA-enabled FMCW radar system comprising a leaky-wave antenna (LWA) array as the receiver (Rx) antenna. The LWA array acts as a filter bank for decomposing a wideband incoming signal (such as a frequency-modulated continuous-wave (FMCW) signal) into a plurality of sub-band signals.

After decomposition, each sub-band signal may be used for achieving an improved angle resolution in a manner similar to the single-chain LWA-based radar system. Meanwhile, all sub-band signals may be stitched or combined to enhance the received spectrum bandwidth for an improved range resolution.

In various embodiments, the LWA array may comprise any suitable types of LWAs, which may be based on different host transmission lines (TLs) such as waveguide, substrate integrated waveguide (SIW), microstrip-line, and/or the like.

In some embodiments, the filter bank based, LWA-enabled FMCW radar system may comprise an LWA array as the transmitter (Tx) antenna.

In some embodiments, the filter bank based, LWA-enabled FMCW radar system may comprise a first LWA array as the transmitter (Tx) antenna and a second LWA array as the Rx antenna. In some embodiments, the Tx and Rx LWA arrays may have the same number of LWAs. In some other embodiments, the Tx and Rx LWA arrays may have different numbers of LWAs.

In some embodiments, the filter bank based, LWA-enabled FMCW radar system uses a stitched or combined frequency-space domain for radar operations to realize a wideband detection to each spatial angle. In some embodiments, the LWA array satisfies a magnitude-stitching condition and a phase-stitching condition for stitching or combining the frequency-space domain for radar operations.

Thus, in some embodiments, the filter bank based, LWA-enabled FMCW radar system disclosed herein may provide both a high angle resolution with a good range resolution, which may be useful in applications requiring detection of objects with a high angle resolution and a moderate range resolution.

In embodiments where the angle resolution is predetermined, the filter bank based, LWA-enabled FMCW radar system disclosed herein may provide a higher range resolution by using more LWA channels. Alternatively, in embodiments where the range resolution is predetermined, the filter bank based, LWA-enabled FMCW radar system disclosed herein may provide a higher angle resolution by using more LWA channels. Thus, the filter bank based, LWA-enabled FMCW radar system disclosed herein provides more design flexibility compared to traditional radar systems.

The filter bank based, LWA-enabled FMCW radar system disclosed herein may provide good radar detection performances for a certain FOV coverage without the need of lossy and expensive phase-shifting components (such as phase shifters or True-Time-Delay (TTD) components) in phased-array radar systems.

Therefore, the filter bank based, LWA-enabled FMCW radar system disclosed herein may be an effective solution for high-frequency radar front-end to provide wideband operation while simultaneously providing the required beam-scanning.

In some embodiments, the LWA array as a filter bank may be used in wideband communication applications for beam-forming, beam-scanning, and/or joint designs of wireless communications and radar sensing.

According to one aspect of this disclosure, there is provided a module comprising: a transmitter (Tx) antenna; and a receiver (Rx) antenna; at least one of the Tx and Rx antennas comprises a leaky-wave antenna (LWA) array for transmitting or receiving one or more signal beams with a range resolution and an angle resolution, the LWA array comprising a plurality of N LWAs configured as a filter bank, where N is an integer greater than 1.

In some embodiments, the plurality of LWAs have a same group delay; and beam-scanning functions (BSFs) of the plurality of LWAs have a same beam-scanning rate.

In some embodiments, each adjacent pair of LWAs of the plurality of LWAs are configured to satisfy a magnitude-stitching condition where the BSFs of the adjacent pair of LWAs are separated by the predefined angular spacing.

In some embodiments, the adjacent pair of LWAs have a fixed phase difference therebetween satisfying a phase-stitching condition where the phase difference therebetween is proportional to the predefined angular spacing multiplied by the group delay and divided by the beam-scanning rate.

In some embodiments, the predefined angular spacing is a predefined beam-width.

In some embodiments, the predefined angular spacing is a 6-dB beam-width.

In some embodiments, the predefined angular spacing is a 9-dB beam-width.

In some embodiments, the LWA array has a spectrum bandwidth proportional to N and a predefined angular spacing, and inversely proportional to the beam-scanning rate.

In some embodiments, the range resolution and the angular resolution of the LWA array satisfy a condition where a production of the range resolution and the angular resolution equals to a production of the beam-scanning rate and a light speed in free space divided by 2\sqrt{2}N.

In some embodiments, the plurality of LWAs are based on one or more host transmission lines (TLs).

In some embodiments, the one or more TLs comprises one or more waveguides, one or more substrate integrated waveguides (SIWs), and/or one or more microstrip-lines.

In some embodiments, the plurality of LWAs comprises a plurality of periodic LWAs with different periods.

According to one aspect of this disclosure, there is provided a process for fabricating the above-described module, the process comprising: selecting a reference periodic LWA of the plurality of LWAs with a predefined broadside frequency f_{bi} and a 3-dB beam-width Δθ_{3 dB}; determining the number N of the plurality of LWAs for implementing the filter bank based on the range resolution; and determining parameters of one or more unit cells of each of the plurality of LWAs for fabricating the module.

In some embodiments, the reference periodic LWA is an i-th LWA of the plurality of LWAs, wherein i is an integer constant that is closest to (N+1)/2.

In some embodiments, said selecting the reference periodic LWA comprises: using the angle resolution as the 3-dB beam-width Δθ_{3 dB}.

In some embodiments, said selecting the reference periodic LWA comprises: determining a period length Pᵢ and a number of one or more unit cells Qᵢ of the reference periodic LWA; and determining beam-scanning rate Sₘ and group delay GD of the reference periodic LWA.

In some embodiments, said determining the period length Pᵢ and the number of one or more unit cells Q of the reference periodic LWA comprises: determining the period length Pᵢ and the number of one or more unit cells Qᵢ of the reference periodic LWA using:

$${θ}_{m} ( f ) \approx {sin}^{- 1} ( \frac{{β}_{0} - \frac{2 π}{{P}_{i}}}{{k}_{0}} ) , \\ {Δθ}_{3 dB} \approx \frac{0.91}{( {Q}_{i} {P}_{i} / {λ}_{0} ) cos ( {θ}_{m} )}$$

where f represents frequency, θₘ(f) is the BSF of the reference LWA, k₀ and λ₀ are free-space wavenumber and wavelength, respectively, β₀ represents a phase constant of a fundamental space-harmonic of the reference periodic LWA, and Δθ_{3 dB} represents a 3-dB beam-width of the reference periodic LWA, and using

$${θ}_{m} ( f ) \approx {sin}^{- 1} ( \sqrt{{ε}_{eff}} - \frac{c}{{P}_{i}} \frac{1}{f} )$$

where ε_{eff} is an effective relative permittivity of a host transmission line (TL) of the reference periodic LWA, and c represents a light speed in free space.

In some embodiments, said determining the number N of the plurality of LWAs comprises: determining the number N of the plurality of LWAs based on the beam-scanning rate of the reference periodic LWA and the range resolution according to:

$$Δ R \cdot Δθ = \frac{2}{2 \sqrt{2} N} {S}_{m}$$

where ΔR represents the range resolution, Δθ represents the angle resolution, and Sₘ represents the beam-scanning rate.

In some embodiments, said determining the number N of the plurality of LWAs comprises: determining a period length of the LWAs adjacent the reference periodic LWA; and selecting a number of unit cells of each of the LWAs adjacent the reference periodic LWA.

In some embodiments, said determining the period length of the LWAs adjacent the reference periodic LWA comprises: determining a period length Pⱼ of the LWAs adjacent the reference periodic LWA according to:

$$\{ \begin{matrix}{P}_{j} = \frac{\sqrt{{ε}_{eff}}}{( j - i ) \sqrt{2} {Δθ}_{3 dB} + \sqrt{{ε}_{eff}}} {P}_{i} , j = i , i + 1 , i + 2 , … \\ or \\ {P}_{j} = \frac{\sqrt{{ε}_{eff}}}{\sqrt{{ε}_{eff}} - ( i - j ) \sqrt{2} {Δθ}_{3 dB}} {P}_{i} , i = i - 1 , i - 2 , …\end{matrix}$$

In some embodiments, said selecting the number of unit cells of each of the LWAs adjacent the reference periodic LWA comprises: selecting the number of unit cells of each of the LWAs adjacent the reference periodic LWA equals to the number of unit cells of the reference periodic LWA.

According to one aspect of this disclosure, there is provided a radar comprising the above-described module.

According to one aspect of this disclosure, there is provided a communication apparatus comprising the above-described module.

### BRIEF DESCRIPTION OF THE DRAWINGS

FIG. 1 is a simplified block diagram of a frequency-modulated continuous-wave (FMCW) radar system having a transmitter (Tx) antenna and a receiver (Rx) antenna;

FIG. 2A is a simplified frequency-space diagram showing the frequency-space coverage of a conventional wideband fixed-beam used by the FMCW radar system shown in FIG. 1;

FIG. 2B is a simplified frequency-space diagram showing the frequency-space coverage of the FMCW radar system shown in FIG. 1 by using mechanical or electrical beam-scanning of the wideband fixed-beam shown in FIG. 2A;

FIG. 3 is a frequency-time diagram showing the waveforms of typical Tx and Rx FMCW beams of the FMCW radar system shown in FIG. 1;

FIG. 4A is a simplified frequency-space diagram showing the frequency-space coverage of a leaky-wave antenna (LWA) beam used by an LWA-enabled FMCW radar system shown in FIG. 1, according to some embodiments of this disclosure;

FIG. 4B is a simplified frequency-space diagram showing the frequency-space coverage of the LWA-enabled FMCW radar system shown in FIG. 1 by using the LWA beam shown in FIG. 4A;

FIG. 5A is a schematic diagram showing the beam coverage of the LWA-enabled FMCW radar system shown in FIG. 1 using an LWA as its Rx antenna;

FIG. 5B is a frequency-space diagram showing the beam-scanning function (BSF) of the Rx LWA of the LWA-enabled FMCW radar system shown in FIG. 1;

FIG. 5C is a frequency-time diagram showing the waveforms of the Tx and Rx beams of the LWA-enabled FMCW radar system shown in FIG. 1;

FIG. 6A is a simplified block diagram of an LWA-enabled FMCW radar system, according to some embodiments of this disclosure, the LWA-enabled FMCW radar system comprising a Rx LWA array having a plurality of LWAs configured as a filter bank;

FIG. 6B is a simplified block diagram showing the functions of a digital signal processing (DSP) component of the LWA-enabled FMCW radar system shown in FIG. 6A;

FIG. 7A is a simplified block diagram showing a filter bank having a plurality of bank-pass filters;

FIG. 7B is a simplified magnitude-frequency and phase-frequency diagram showing the transfer functions of the bank-pass filters of the filter bank shown in FIG. 7A;

FIG. 8 is a frequency-space diagram showing interleaved BSFs of the LWAs of the LWA-enabled FMCW radar system shown in FIG. 6A;

FIG. 9 is a frequency-time diagram showing the chirp signals transmitted from a Tx antenna and chirp signals received from the Rx LWA array of the LWA-enabled FMCW radar system shown in FIG. 6A;

FIGS. 10A to 13B show simulation results of normalized received power spectrums of an LWA-enabled FMCW radar system having one Rx LWA channel (FIGS. 10A and 10B), two Rx LWA channels under 6-dB overlap criteria (FIGS. 11A and 11B), three Rx LWA channels under 6-dB overlap criteria (FIGS. 12A and 12B), and three Rx LWA channels under 9-dB overlap criteria (FIGS. 13A and 13B), wherein

FIGS. 10A, 11A, 12A, and 13A show heat-maps each representing a corresponding received power spectrum with respect to different angles-of-target (AoTs), and

FIGS. 10B, 11B, 12B, and 13B show the corresponding received power spectrums in a special situation that the target is in the broadside direction (the direction perpendicular to the plane of the LWAs, that is, AoT=0);

FIGS. 14A to 17B show simulation results of normalized radiation patterns of an LWA-enabled FMCW radar system having one Tx LWA channel (FIGS. 14A and 14B), two Tx LWA channels under 6-dB overlap criteria (FIGS. 15A and 15B), three Tx LWA channels under 6-dB overlap criteria (FIGS. 16A and 16B), and three Tx LWA channels under 9-dB overlap criteria (FIGS. 17A and 17B), wherein

FIGS. 14A, 15A, 16A, and 17A show heat-maps each representing a corresponding normalized radiation pattern with respect to different frequencies, and

FIGS. 14B, 15B, 16B, and 17B show the corresponding radiation patterns at the carrier frequency of 35 GHZ;

FIG. 18 is a flowchart showing a design process for designing a generalized filter bank based LWA array, according to some e embodiments of this disclosure;

FIG. 19 is a diagram showing normalized phase constant of a filter bank based LWA array;

FIGS. 20A to 20C show an LWA array designed using the design process shown in FIG. 18 based on the stub-loaded-resonator (SLR)-based microstrip combline LWA, wherein

FIGS. 20A and 20B are the perspective view and plan view, respectively, of a unit cell of the filter bank based LWA array, and

FIG. 20C is the perspective view of the LWA array;

FIG. 21A to 21D show simulation results of electrical behaviors of a reference LWA (denoted LWAᵢ) and an LWA (denoted LWA₍ᵢ₊₁₎) adjacent to LWAᵢ in the filter bank based LWA array, wherein

FIG. 21A shows simulation results of the scattering parameters of LWAᵢ and LWA₍ᵢ₊₁₎,

FIG. 21B shows the normalized radiation patterns of LWAᵢ and LWA₍ᵢ₊₁₎,

FIG. 21C shows the main-beam direction and the two-dimensional (2D) realized gain pattern of LWAᵢ,

FIG. 21D shows the main-beam direction and the two-dimensional (2D) realized gain pattern of LWA₍ᵢ₊₁₎;

FIGS. 22A to 22D show the normalized received power spectrums of LWAᵢ and LWA₍ᵢ₊₁₎ when they are illuminated by a wideband uniform plane-wave with the phase center (or zero-phase point) located at the antenna surface, wherein

FIGS. 22A and 22B show the normalized received power spectrums and phase spectrum of the LWAᵢ and LWA₍₊₁₎ when the incident angle of the plane-wave is 0°, and

FIGS. 22C and 22D show the normalized received power spectrums of LWAᵢ and LWA₍ᵢ₊₁₎ under the incident angles of the plane-wave of −10° and 10°, respectively;

FIG. 23A shows an LWA array having two SLR-based microstrip combline LWAs connected to a two-way waveguide/substrate integrated waveguide (SIW) power divider, wherein the parameters shown therein are in millimeters;

FIG. 23B is a photo showing a prototype of the LWA array shown in FIG. 23A, wherein a coin is also shown therein for size comparison;

FIG. 23C shows a measurement setup in compact antenna test range;

FIGS. 24A and 24B show simulation results of the scattering parameters of the two-way SIW power divider shown in FIG. 23A in terms of the magnitude frequency responses (FIG. 24A) and phase frequency responses (FIG. 24B); and

FIGS. 25A to 25D show simulated and measured results of the LWA array shown in FIG. 23A, wherein

FIG. 25A shows the simulated and measured results of the simulated scattering parameter |S11| of the LWA array shown in FIG. 23A,

FIG. 25B shows the simulated gain pattern of the LWA array shown in FIG. 23A at different frequencies,

FIG. 25C shows the measured normalized power spectrum of the LWA array shown in FIG. 23A towards different AoTs, and

FIG. 25D shows the measured gain of the LWA array shown in FIG. 23A as a function of both angle and frequency.

### DETAILED DESCRIPTION

Embodiments disclosed herein relate to systems, devices, apparatuses, modules, circuitries, and methods for effectively and efficiently generating wideband beams for scanning and sampling a target frequency-space. The systems, devices, apparatuses, modules, circuitries, and methods disclosed herein may be used in various radar applications and/or communication applications.

In some embodiments, the system disclosed herein uses a leaky-wave antenna (LWA) array as a filter bank, for wideband operations towards a specific spatial angle within its field of view (FoV) with improved range and/or angle resolutions. By using the LWA array, the system disclosed herein provides a low-cost and low-complexity solution without using any lossy and expensive phase-shifting components.

### A. Radar System Structure

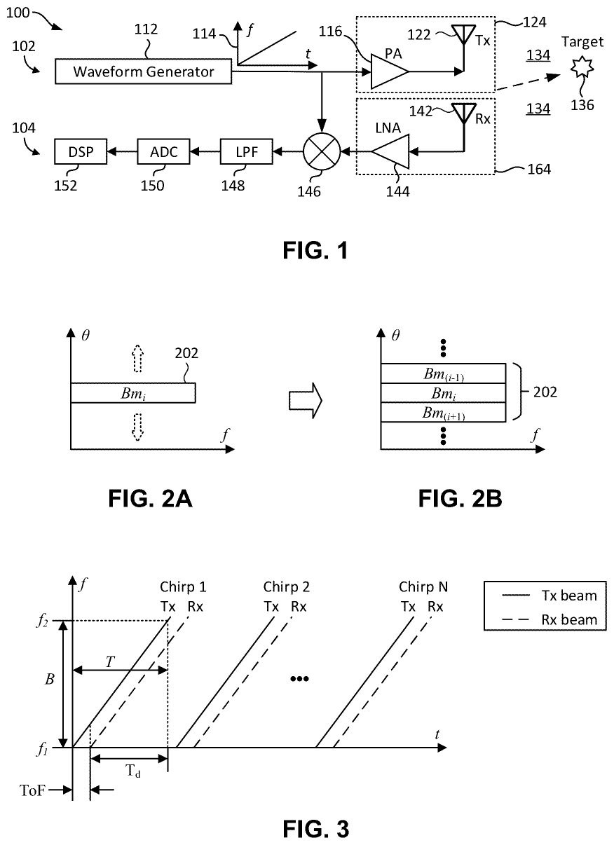

Turning now to FIG. 1, a radar system is shown and is generally identified using reference numeral 100. As shown, the radar system 100 comprises a transmitter (Tx) 102 and a receiver (Rx) 104. The transmitter 102 comprises a waveform generator 112 generating a Tx radio frequency (RF) signal 114 (represented by the simplified frequency-time diagram thereof), which is amplified by a power amplifier (PA) 116 and then transmitted through a Tx antenna 122. Herein, the PA 116 and the Tx antenna 122 form the front end 124 of the transmitter 102. The rest of the transmitter 102 may be denoted a backend thereof.

In these embodiments, the transmitter 102 uses a waveform-generating technology to form the RF signal 114 and transmit the RF signal 114 as an RF beam in a specific frequency band and towards a specific angular range (that is, towards a specific direction with a specific angular span). By shifting the beam's frequency band and/or angular range or by forming a plurality of beams of various frequency bands and/or angular ranges, the radar system 100 may scan and sample a target frequency-space 134 (that is, a target frequency band in a target angular range).

One or more target objects 136 in the target frequency-space 134 may reflect a RF beam and cause reflected RF signals received by the receiver (Rx) 104 of the radar system 100. As those skilled in the art will understand, the reflected RF signals are generally time-delayed and attenuated duplicates of the transmitted RF signal 114.

Alternatively, one or more target objects 136 may transmit one or more RF beams which may be received by the receiver 104 of the radar system 100. Herein, the one or more RF beams transmitted from the target objects 136 are known to the radar system 100 (for example, being duplicates of the transmitted RF signal 114).

The receiver (Rx) 104 of the radar system 100 comprises an Rx antenna 142 receiving the reflected RF signals which are amplified by a low-noise amplifier (LNA) 144 and then combined with a copy of the Tx RF signal 114 via a mixer 146 to produce an intermediate frequency (IF) signal. The IF signal is filtered by a low-pass filter (LPF) 148 and converted to the digital domain via an analog-to-digital converter (ADC) 150. The digitalized signal is then processed by a digital signal processing (DSP) module 152, for example, using a two dimensional (2D) Fast Fourier Transform (FFT) method (also called Range-Doppler FFT), to detect the one or more target objects 136 and to estimate and resolve the range and velocity parameters thereof. Herein, the Rx antenna 142 and LNA 144 form the front end 164 of the receiver 104. The rest of the receiver 104 may be denoted a backend thereof.

For case of illustration, the radar system 100 shown in FIG. 1 only comprise one Tx-Rx chain (that is, one Tx antenna 122 and one Rx antenna 142). However, those skilled in the art will appreciate that the radar system 100 in other embodiments (such as automotive radars) may comprise multiple Tx antennas 122 and/or multiple Rx antennas 142 for improved angle estimation/resolution capabilities with improved detection performances, and the description below with respect to the radar system structure shown in FIG. 1 may be easily expanded to radar systems with multiple Tx/Rx antennas.

Herein, the radar system 100 is a frequency-modulated continuous-wave (FMCW) radar system wherein the Tx RF signal beam 106 transmitted through the Tx antenna 110 is a frequency-modulated continuous-wave RF signal or beam.

The FMCW beam may be a wideband fixed-beam. FIGS. 2A and 2B are simplified frequency-space diagrams showing the wideband fixed-beam 202 used in traditional mechanical or electrical beam-scanning. As shown in FIG. 2A, the wideband fixed-beam 202 has a fixed, narrow angular width or span and a wideband covering the entire target frequency-range. As shown in FIG. 2B, by shifting the wideband fixed-beam 202 across the entire target angular-range using mechanical or electrical means or by forming a plurality of wideband fixed-beams 144 across the entire target angular-range, the entire target frequency-space is then scanned.

FIG. 3 is a frequency-time diagram showing the waveforms of typical Tx and Rx FMCW beams. In these embodiments, the Tx and Rx FMCW beams in the frequency-time domain are wideband chirp-signals (also denoted “chirp-sequences”) each having N chirps within a coherent processing interval (CPI; also denoted a “frame”).

As shown in FIG. 3, the Tx and Rx antennas 122 and 142 generally operate with a fixed-beam over the whole spectrum bandwidth of the chirp signals, which means that toward any spatial directions within the target frequency-space 134, all frequency components of the Tx chirp signal may be radiated out from the Tx antenna 122 and (if reflected by the target object 136) then captured by the Rx antenna 142 (as the Rx chirp signal) generally without any substantive magnitude/phase distortion. The relevant frequency-space coverage of the chirp signal is illustrated in FIG. 2A.

The range resolution of the radar system 100 may be expressed as:

$$Δ R = \frac{c}{2 B} \frac{T}{{T}_{d}} \approx \frac{c}{2 B} \qquad ( 1 )$$

where c represents the light speed in free space, B is the nominal spectrum bandwidth of the chirp signal, T denotes the sweeping time of the chirp, and T_{d} stands for the measurable time-duration of the IF signal (see FIG. 3). Herein, the round-trip time-of-flight (ToF) of the signal is generally much smaller than the sweeping time T of the chirp signal (see FIG. 3). Thus, T≈T_{d} and the approximation in Equation (1) is valid. Consequently, nearly the whole spectrum bandwidth of the chirp signal may be dedicated to the range resolution. In other words, the spectrum bandwidth of the chirp signal determines the range resolution of the radar system 100. On the other hand, in applications wherein the radar system comprises multiple Rx antennas 142 (each equipped with a channel) to estimate and resolve the targets' angle information, the angle resolution Δθ is equal to the 3-dB beam-width Δθ_{3 dB} of the whole Rx antenna array. The velocity resolution is mainly determined by the CPI and the carrier frequency f_{c} of the chirp signal waveform, and is irrelevant to both the available spectrum bandwidth of the received signal and the number of Rx channels.

Although the range resolution of a conventional FMCW radar system may be refined by increasing the spectrum bandwidth of the signal waveform according to Equation (1), a good angle resolution however can only be achieved if the radar is equipped with multiple Rx antenna elements or channels, and higher angle resolution requires more Rx channels in the radar system (for example, in automotive radar systems where the “point cloud” data are needed for high-quality imaging for autonomous driving), thereby causing various disadvantages such as high cost, large system layout, heavy data volume/computation burden, complicated DSP algorithms, cumbersome channel calibration and maintenance, severe power consumption, and/or the like. Thus, a conventional FMCW radar system in practice may only comprise a small number of Rx channels such as a 3Tx-4Rx radar system giving rise to 12 virtual Rx channels. Examples of such radar systems may be the automotive radar sensor series such as AWR1243, AWR1443, and AWR1843 offered by Texas Instruments of Dallas, Texas, USA, which primarily focus on wideband FMCW signal waveforms with a good range resolution to provide reasonable radar performances and the angle resolution thereof is secondary.

### B. Leaky-Wave Antenna (LWA) Enabled FMCW Radar System

According to one aspect of this disclosure, the radar system 100 may be a leaky-wave antenna (LWA) enabled FMCW radar system.

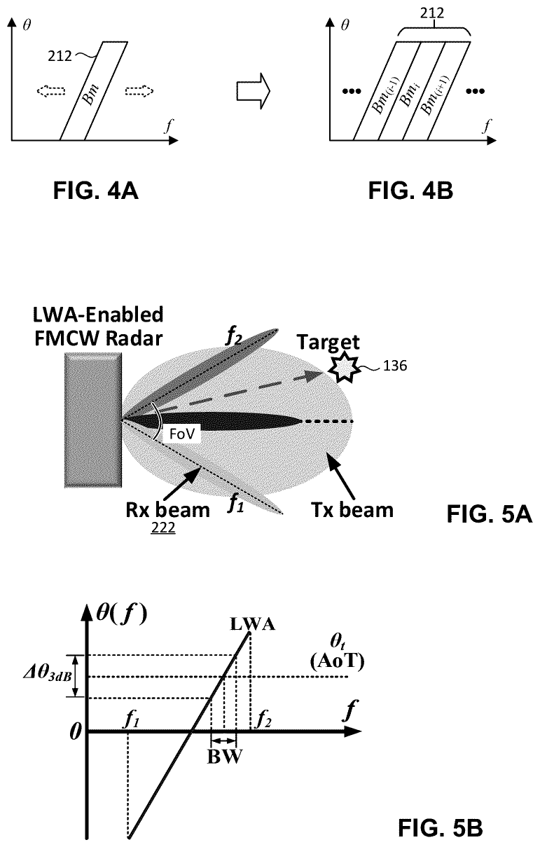

LWA is a member of the travelling-wave antenna class. FIG. 4A is a simplified frequency-space diagram showing the frequency-space domain coverage of an LWA beam 212 (that is, a beam formed by an LWA; denoted a “Bm” in FIG. 2A). As shown, the LWA beam 212 has a large angular span covering an entire target-space, with a narrow frequency-band as a function of the scanning angle θ. As shown in FIG. 4B, by shifting the LWA beam 212 across the entire target frequency-range or by forming a plurality of LWA beams 142 across the entire target frequency-range, the radar system 100 then scans the entire target frequency-space.

As those skilled in the art will appreciate, while the wideband, directional and fixed-beam antennas described above normally work in a standing-wave mechanism for example, slotted waveguides/substrate integrated waveguides (SIWs) and series-fed microstrip patches/stubs, LWA has numerous appealing features such as the directive and narrow beam and particularly the natural frequency-enabled beam-scanning property. Thus, LWAs may provide a low-cost, low-complexity, and simple beam-scanning solution with a good angle resolution, and several other benefits compared to the traditional antenna technologies.

For example, compared to the mechanical beam-scanning, LWA's frequency-enabled beam-scanning is apparently much faster in scanning the target frequency-space without the need of inertial devices. Compared to the multi-beam solution, LWA no longer suffers from cumbersome arrangement of illumination sources or complicated beamforming circuits. Moreover, compared to the phased-array techniques, LWA may eliminate the expensive and lossy phase shifters/time delay devices and related controlling circuits.

As those skilled in the art will appreciate, a radar system is often required to detect multiple targets with a good range resolution over a certain FoV during scanning. While LWA provides above-described beam-scanning benefits, its beam's narrowband nature may cause some issues. For example, while LWA-based radars may benefit from their frequency-enabled beam-scanning features as described above, they may experience undesirable degradations of certain radar performances such as the reduced available spectrum bandwidth along with deteriorated range resolution in each spatial angle cell. In particular, the LWA-based radars may have a coupling-related issue between the range and angle resolutions, which may be one of the reasons that there are merely a countable number of works in LWA-based radars that have been reported so far in radio-frequency (RF) and microwave communities, even though a large variety of LWAs based on multifarious transmission lines (TLs), radiating discontinuities, and radiation mechanisms have been developed and studied since 1940s.

With the above-described advantages and disadvantages, the characteristics of the LWA-enabled FMCE radar system is now described.

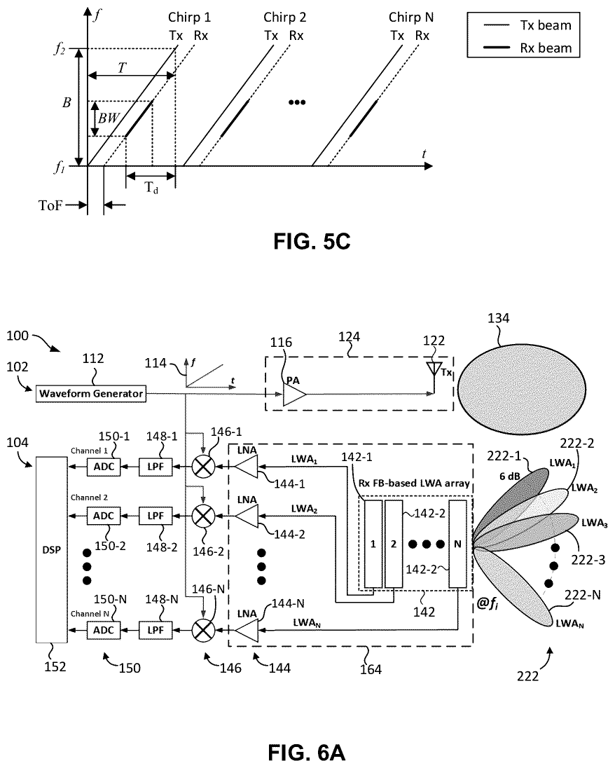

In some embodiments, the radar system 100 is an LWA-enabled FMCW radar system with the Rx antenna 142 being an LWA. FIG. 5A shows the beam-coverage scenario of the LWA-enabled FMCW radar system 100. Within the working frequency band ranged from f₁ to f₂ (that is, the bandwidth of the chirp waveform B=f₂−f₁), the Tx beam is kept fixed, and the Rx beam is scanned backward to forward as shown in FIG. 5B. Thus, the Rx LWA 142 may receive signals when the target 136 is “seen” by the Rx beam 222 or when the Rx beam 222 dwells on the target 136. Therefore, the frequency contents of the received signals are dependent on the spatial angles of targets 136, which enable the LWA to present a spatially dependent band-pass behavior.

In these embodiments, the Rx LWA 142 has a linear beam-scanning function (BSF) θₘ(f) with a beam-scanning rate Sₘ, that is, θₘ(f)=Sₘ·f+bₘ, (see FIG. 5B, where Sₘ is the slope of the LWA line) and a constant 3-dB beam-width Δθ_{3 dB} that does not change with frequency. For a certain angle-of-target (AoT, which is the direction where the target 136 is located), the spectrum bandwidth BW of the received chirp signal is:

$$BW = \frac{{Δθ}_{3 dB}}{{S}_{m}} \qquad ( 2 )$$

Clearly, the spectrum bandwidth BW of the received chirp signal is narrower than the spectrum bandwidth of the transmitted chirp signal since most frequency contents of the transmitted chirp signal cannot be captured by the Rx LWA 142, as illustrated in FIG. 5C. Consequently, the time-duration T_{d} of the IF signal is significantly shortened and thus the frequency resolution after performing the Range-FFT is deteriorated. Thus, the range resolution formulated in Equation (1) becomes:

$$Δ R = \frac{c}{2 BW} \qquad ( 3 )$$

which is significantly deteriorated. Considering that the angle resolution Δθ of the LWA-enabled FMCW radar system 100 is equal to the 3-dB beam-width Δθ_{3 dB} of the LWA, by substituting Equation (2) into Equation (3), the range resolution ΔR and the angle resolution Δθ has a relationship as:

$$Δ R \cdot Δθ = \frac{c}{2} {S}_{m} \qquad ( 4 )$$

Equation (4) shows that, the range resolution ΔR and the angle resolution Δθ of the LWA-enabled FMCW radar system 100 are coupled and contradictory for a given beam-scanning rate Sₘ of LWAs. This is easily understandable since the two resolution metrics ΔR and Δθ are set to rely on the 3-dB beam-width of the Rx LWA but have reverse trends.

Although an LWA-enabled FMCW radar system 100 may provide a low-cost and low-complexity beam-scanning solution with a single pair of Tx/Rx antennas, the range resolution thereof is compromised due to the nominal spectrum of the signal waveform (for example, the chirp signal) being shared by both the beam-scanning and range resolution (that is, the narrowband nature of an LWA towards a specific spatial angle; see FIG. 4A). This issue would be further deteriorated when a high angle resolution is needed, according to Equation (4). Therefore, a performance tradeoff between the attainable range and angle resolutions is usually required for practical radar applications. Moreover, the transmission rate/quality and communication capacity of communication applications using LWAs may also be compromised because of the narrowband nature of LWAs towards a specific spatial angle or user.

### C. Frequency-Space Domain Stitching Using Filter Bank

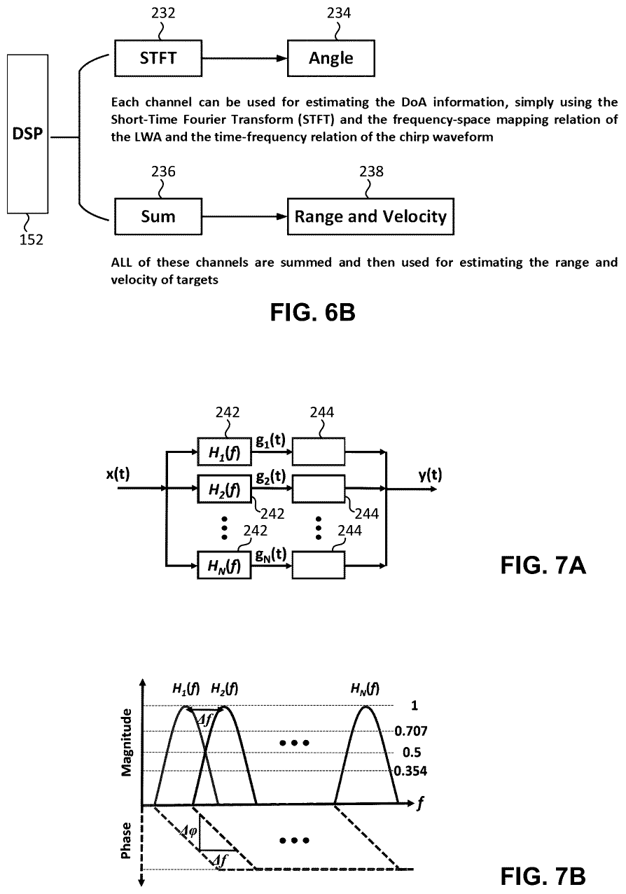

FIG. 6A is a simplified block diagram of an LWA-enabled FMCW radar system 100 according to some embodiments of this disclosure, for solving at least some issues described in above subsection. In these embodiments, the transmitter 102 of the LWA-enabled FMCW radar system 100 is the same as that shown in FIG. 1. The receiver 104 thereof uses an LWA array having a plurality of LWAs as a filter bank for decomposing a wideband incoming signal (such as a FMCW signal) into a plurality of sub-band signals.

As shown in FIGS. 7A and 7B, a filter bank is a bank of frequency-overlapped band-pass filters 242 having frequency responses or transfer functions H₁(f), H₂(f), . . . , H_{N}(f), respectively, for dividing an input signal x(t) into a plurality of band-pass signals g₁(t), g₂(t), . . . , g_{N}(t), each of which may be separately processed by a respectively signal-processing component 244. The outputs of the signal-processing components 244 may be separately output for further processing (not shown), or summed together to form a single output signal y(t).

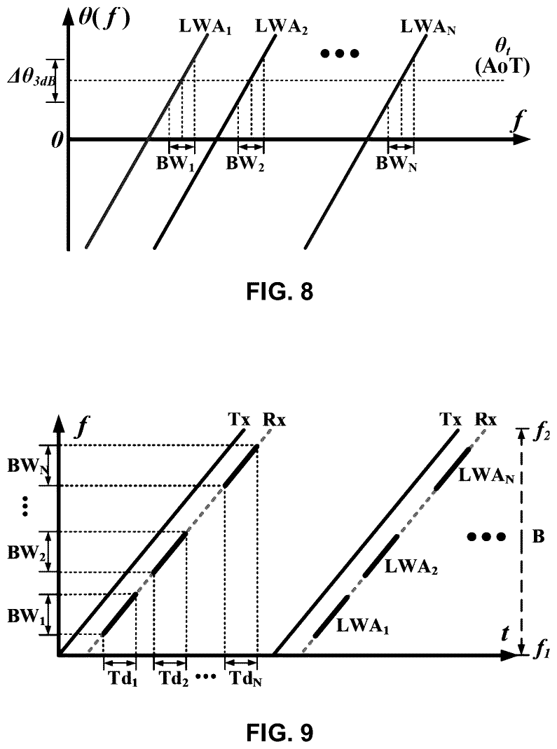

Referring back to FIG. 6A, the receiver 104 of the LWA-enabled FMCW radar system 100 in these embodiments uses an array of N (N>1) LWAs 142-1, 142-2, . . . , 142-N (collectively identified using reference numeral 142) with different BSFs (see FIG. 8 for their frequency-space diagrams) as a filter bank to divide the received wideband beam signal (for example, the reflected chirp signal) into a plurality of sub-band signals LWA₁, LWA₂, . . . , LWA_{N} for subsequent processing (the LWA and the subsequent components for processing each sub-band signal LWAⱼ (1≤j≤N) is denoted an LWA channel). FIG. 9 is a frequency-time diagram showing the Tx chirp signal and the sub-band signals LWA₁, LWA₂, . . . , LWA_{N}.

As shown in FIG. 6A, in the j-th LWA channel (that is, the LWA 142-j outputs a sub-band signal LWAⱼ which is amplified by the LNA 144-j and then combined with a copy of the Tx RF signal 114 via the mixer 146-i to produce an intermediate frequency (IF) signal. The IF signal is filtered by a LPF 148-j and converted to the digital domain via an ADC 150-j. The digitalized signals of all channels are then set to the DSP module 152 for processing.

As shown in FIG. 6B, the DSP 152 applies a short-time Fourier transform (STFT) 232 such as a 2D FFT to the digitized signal of each channel and for direction-of-arrival (DOA) estimation 234 (that is, angle estimation) using the frequency-space mapping relationship of the LWA and the time-frequency relationship of the chirp waveform. The DSP 152 also calculates the sum of the digitalized signals of all channels (block 236) for estimating the range and velocity of one or more targets (block 238).

As those skilled in the art will appreciate, an LWA behaves as a spatially-dependent band-pass filter that has different spectrum passbands toward different AoTs. Then, for a given AoT, the plurality of Rx LWAs 142 with suitably overlapped frequency responses may form different channels similar to the beams shown in FIG. 4B.

Thus, the individual received spectrums of the Rx LWAs 142 may be coherently “stitched” or combined in a backend module. The LWA array 142 then provides a spectrum bandwidth wider than that of a single LWA, and the range resolution of the filter bank based, LWA-enabled FMCW radar system 100 shown in FIG. 6A may be significantly improved according to Equation (3), while the angle resolution thereof remains the same as that of a single LWA. Specifically, all LWA channels may corporately contribute to the range resolution, while each of them may be used for the angle resolution.

Generally, more LWA channels may give rise to higher range resolution. As will be described below, the filter bank based, LWA-enabled FMCW radar system 100 shown in FIG. 6A uses each LWA channel for providing angle resolution and uses the combination of all LWA channels for providing the range resolution, which is opposite to the traditional phased-array related FMCW radar system, where each Rx channel provides the range resolution while all channels are combined for the angle resolution.

Those skilled in the art will appreciate that, to obtain a gapless and stitched/combined frequency-space coverage (see FIG. 4B) for the filter bank based, LWA-enabled FMCW radar system 100 shown in FIG. 6A, the transfer function of each band-pass filter or LWA channel need to be deliberately organized to ensure that the summed transfer function gives rise to a widened and relatively flat frequency response toward any spatial angles within the FoV. This requirement may be translated to several stitching conditions or design specifications, such as, engineered BSFs, beam-crossovers, and phase alignments, for an array of LWAs 142, as will be described below.

In the following, an LWA-enabled FMCW radar system 100 having a single Rx LWA 142 is first analyzed (which is applicable to any one of the LWA channels), followed by the details of the filter bank based, LWA-enabled FMCW radar system 100 having an LWA array as the Rx antenna.

For a single Tx-Rx chain of the LWA-enabled FMCW radar system 100 (denoted a “single-LWA FMCW radar system) that uses a single LWA as the Rx antenna 142 and a fixed-beam antenna as the Tx antenna 122, the received power spectrum, according to the radar equation, may be expressed as

$${P}_{r} ( θ , f ) \approx \frac{{P}_{t} ( θ , f ) {G}_{t} ( θ , f ) {G}_{r} ( θ , f ) {σλ}_{c}^{2}}{{( 4 π )}^{3} {R}^{4}} \qquad ( 5 )$$

where Pᵣ is the received power of the Rx antenna 142, Pₜ is the transmitted power of the Tx antenna 122, Gₜ and Gᵣ are the power gains of the Tx and Rx antennas 122 and 142, respectively, R refers to the distance between the target and the radar, σ represents the radar cross section (RCS) of the target, while λ_{c} denotes the free-space wavelength of the chirp signal's carrier frequency f_{c}. The parameters Pᵣ, Pₜ, Gₜ, and Gᵣ are functions of both the frequency f and the spatial angle θ (without loss of generality, only one plane is considered here, which corresponds to the scanning plane of the Rx LWA or the azimuth plane of the radar).

For the convenience of analysis yet without loss of generality, the transmitted power Pₜ is considered a constant over frequencies, for example, one (1) Watt. This consideration is reasonable since the chirp waveform has a nearly uniform power spectrum. Considering that the Tx antenna 122 is a fixed-beam antenna over the frequency band of operation, the power gain Gₜ is set to be unity for simplicity (it may be different for other directions but still remain a constant over frequencies). As for the Rx LWA 142 that has a fixed 3-dB beam-width of Δθ_{3 dB} and a linear BSF of θₘ(f)=Sₘ·f+bₘ as described above, its absolute power gain radiation pattern is modeled by a normalized Gaussian function, that is, a Gaussian LWA, which is expressed as

$${G}_{r} ( θ , f ) = {e}^{\{ \frac{- 2 ln {4 [ θ - {θ}_{m} ( f ) ]}^{2}}{{Δθ}_{3 dB}^{2}} \}} \qquad ( 6 )$$

Obviously, it can be deduced from Equation (6) that for a certain spatial angle, the power-gain frequency response of the Rx LWA 142 is also related to a Gaussian profile. Thus, the received power spectrum of the single-LWA FMCW radar system 100 towards this angle may also be approximately with a Gaussian profile because of its linear relationship with the power gain of the Rx LWA 142 under above-mentioned considerations. Moreover, the physical significance of an antenna's transfer function is actually manifested by or equivalent to its voltage gain/field pattern. Thus, the transfer function of the Rx LWA 142 may be expressed as

$$\vert {H}_{r} ( θ , f ) \vert = \sqrt{{G}_{r} ( θ , f )} \qquad ( 7 )$$

The received voltage magnitude spectrum can be then expressed as

$$\vert {U}_{r} ( θ , f ) \vert = \sqrt{2 Re ( {Z}_{0} ) {P}_{r} ( θ , f )} = g \cdot \vert {H}_{r} ( θ , f ) \vert \qquad ( 8 )$$

where Zₒ is the load impedance of the Rx antenna 142 and g=\sqrt{2Re(Z₀)σλ_{c}²/[(4π)³R⁴]} is a constant.

In the filter bank based, LWA-enabled FMCW radar system 100 shown in FIG. 6A, where an array of N LWA channels are used to receive signals simultaneously, the total magnitude spectrum of the resultant voltage signal from these Rx LWA channels may be derived as

$$\vert {U}_{rt} ( θ , f ) \vert = \vert {\sum }_{j = 1}^{N} {U}_{rj} ( θ , f ) \vert = {\sum }_{j = 1}^{N} \vert {U}_{rj} ( θ , f ) \vert = g \cdot {\sum }_{j = 1}^{N} \vert {H}_{rh} ( θ , f ) \vert \qquad ( 9 )$$

where Uᵣₜ(θ, f) represents the spectrum of the combined voltage signal, and Uᵣⱼ(θ, f) and Hᵣⱼ(θ, f) denote the output voltage spectrum and transfer function of the j-th LWA, respectively.

In these embodiments, all LWAs 144-1 to 144-N (or equivalently the LWA band-pass filters) have the same group delay (or slope of linear-phase frequency-responses of transfer functions) in their passbands, which is normally the case for a filter bank. In this context, the individual output spectrums of these LWA channels may be added coherently as in Equation (9) when the phase difference 40 between adjacent LWAs 114-j and 144-(j+1) (1≤j<N) in the overlap frequency region (as shown in FIG. 7B) has been compensated before combining the output spectrums of the LWAs 144-1 to 144-N.

Consequently, according to Equation (9) and with reference to FIG. 7B, the transfer functions of the LWAs 144-1 to 144-N need to overlap at suitable frequency points in order to obtain an enhanced spectrum bandwidth of the total received signal at a certain AoT. This requirement may be translated to particular design specifications of these LWAs 144-1 to 144-N, considering that the transfer function of an LWA at a certain angle is determined by its BSF according to Equations (6) and (7).

In order to derive such design specifications of LWAs 144-1 to 144-N, the following considers an array of two adjacent LWA channels 114-j and 144-(j+1) having interleaved BSFs expressed as θₘⱼ(f)=Sₘ·f+bₘⱼ and θₘ₍ⱼ₊₁₎(f)=Sₘ·f+bₘ₍ⱼ₊₁₎, respectively.

As deduced from Equations (6) and (7), the transfer function of a Gaussian LWA, at a given angle, is also with a Gaussian profile that only pertains to frequency, with the 3-, 6-, and 9-dB spectrum bandwidth of Δθ_{3 dB}/Sₘ, Δθ_{6 dB}/Sₘ, and Δθ_{9 dB}/Sₘ, respectively, where Δθ_{6 dB} and Δθ_{9 dB} refer to the 6- and 9-dB radiation beam-widths of the LWA, respectively. To obtain a relatively flat-while-wide summed transfer function, their individual counterparts shall approximately overlap at the frequency point at which a half of the maximum absolute value is reached as illustrated in FIG. 7B. This corresponds to the 6-dB frequency point of each transfer function, indicating that the required frequency offset or distance Δf between the two LWAs' transfer functions is Δθ_{6 dB}/Sₘ. This may be translated to a limiting condition of their BSFs, expressed as

$${θ}_{mj} ( f ) - {θ}_{m ( j + 1 )} ( f ) = {b}_{mj} - {b}_{m ( j + 1 )} = {Δθ}_{6 dB} = \sqrt{2} {Δθ}_{3 dB} \qquad ( 10 )$$

where a scaling factor of \sqrt{2} between Δθ_{3 dB} and Δθ_{6 dB} of the Gaussian LWA is applied (similarly, the scaling factor between Δθ_{3 dB} and Δθ_{9 dB} is \sqrt{3}).

From Equation (10), it may be found that, at a certain frequency f, the two adjacent LWAs 114-j and 144-(j+1) are separated by an angular spacing of Δθ_{6 dB} with respect to their BSFs. This also means that their radiation power gain beams, at a certain frequency, shall be overlapped at the 6-dB angular point, that is, 6-dB beam-crossover. Thus, Equation (10) may be denoted a “magnitude-stitching condition”, which specifies that the BSFs of the two adjacent LWAs 114-j and 144-(j+1) are separated by the predefined angular spacing Δθ_{6 dB}.

As those skilled in the art will appreciate, the design specifications related to Equation (10) such as BSFs and beam-crossovers are subject to the condition that all received spectrums from the LWA channels could be phase-aligned and thus coherently combined. In some embodiments, the two adjacent LWAs 114-j and 144-(j+1) also have a fixed phase difference Δφ between their overlapped spectrums satisfying

$$Δφ \approx 2 π \cdot Δ f \cdot GD = 2 π \cdot \frac{{Δθ}_{6 dB}}{{S}_{m}} \cdot GD \qquad ( 11 )$$

according to the linear phase frequency responses of a filter bank as illustrated in FIG. 7B. Here, GD refers to the same group delay of each band-pass filter in the filter bank (that is, the group delay of the LWAs, including the two adjacent LWAs 114-j and 144-(j+1)), and Δf is selected as Δθ_{6 dB}/Sₘ in accordance with the 6-dB overlap criteria adopted in Equation (10). Thus, Equation (11) may be denoted a “phase-stitching condition”, which specifies that the phase difference the two adjacent LWAs 114-j and 144-(j+1) is proportional to the angular spacing Δθ_{6 dB} multiplied by the group delay GD and divided by the beam-scanning rate Sₘ.

By simultaneously satisfying the magnitude-stitching and phase-stitching conditions of Equations (10) and (11), the LWA array or filter bank may “seamlessly stitch” the LWA channels 142-1 to 142-N in the frequency-space domain, and the individually received spectrum bandwidth from the two Rx LWAs 114-j and 144-(j+1) towards a certain angle may be coherently added and expressed as

$${BW}_{FB - 2 =} \frac{{Δθ}_{3 dB} + {Δθ}_{6 dB}}{{S}_{m}} \qquad ( 12 )$$

Similarly, if an array of N LWA channels is used simultaneously based on the magnitude-stitching and phase-stitching conditions of Equations (10) and (11), the total received spectrum bandwidth may be obtained as

$${BW}_{FB - N =} \frac{{Δθ}_{3 dB} + ( N - 1 ) {Δθ}_{6 dB}}{{S}_{m}} \approx N \frac{{Δθ}_{6 dB}}{{S}_{m}} = \sqrt{2} N \frac{{Δθ}_{3 dB}}{{S}_{m}} \qquad ( 13 )$$

where N>1. As a result, the relationship of the range and angle resolutions formulated in Equation (4) may be revised as

$$Δ R \cdot Δθ = \frac{c}{2 \sqrt{2} N} {S}_{m} \qquad ( 14 )$$

Clearly, for an FMCW radar system having an array of N Rx LWA channels 142 sharing a certain 3-dB beam-width (angle resolution) and beam-scanning rate, the attainable spectrum bandwidth and range resolution may be improved by a factor of \sqrt{2}N when the filter bank related magnitude-stitching and phase-stitching conditions of Equations (10) and (11) are used to construct an expanded and stitched frequency-space domain shown in FIG. 4B for radar operations. Alternatively, for a certain range resolution, a refined angle resolution (narrowed 3-dB beam-width) may be realized by using more LWA channels 142.

Simulations have been conducted to demonstrate the effectiveness of the above-described solution for stitching the frequency-space domain and thus enhancing the received spectrum bandwidth. In the simulations, one, two, and three LWA channels among an N-channel (N≥3) LWA array 142 are used to calculate the total received power spectrum toward different AoTs, respectively. All of these LWAs are modeled with the same beam-scanning rates of 5°/GHz and a Gaussian radiation pattern with the 3- and 6-dB beam-widths of 8.5° and 12°, respectively. The carrier frequency f_{c} is 35 GHZ, which is also the broadside frequency of the reference LWA numbered as LWAᵢ. In the simulations described below, the LWAi is the central LWA among the N-channel LWA array 142 and the subscript i is an integer constant that is closest to (N+1)/2. Based on these parameters and the magnitude-stitching and phase-stitching conditions of Equations (10) and (11), the BSFs of the selected three LWAs may be expressed as

$$\{ \begin{matrix}{θ}_{m ( i - 1 )} ( f ) = 5 ) f - 35 ) + 12 = 5 f - 163 \\ {θ}_{mi} ( f ) = 5 ( f - 35 ) = 5 f - 175 \\ {θ}_{m ( i + 1 )} ( f ) = 5 ( f - 35 ) - 12 = 5 f - 187\end{matrix} \qquad ( 15 )$$

The numbering and arrangement of these LWAs is consistent with FIG. 8.

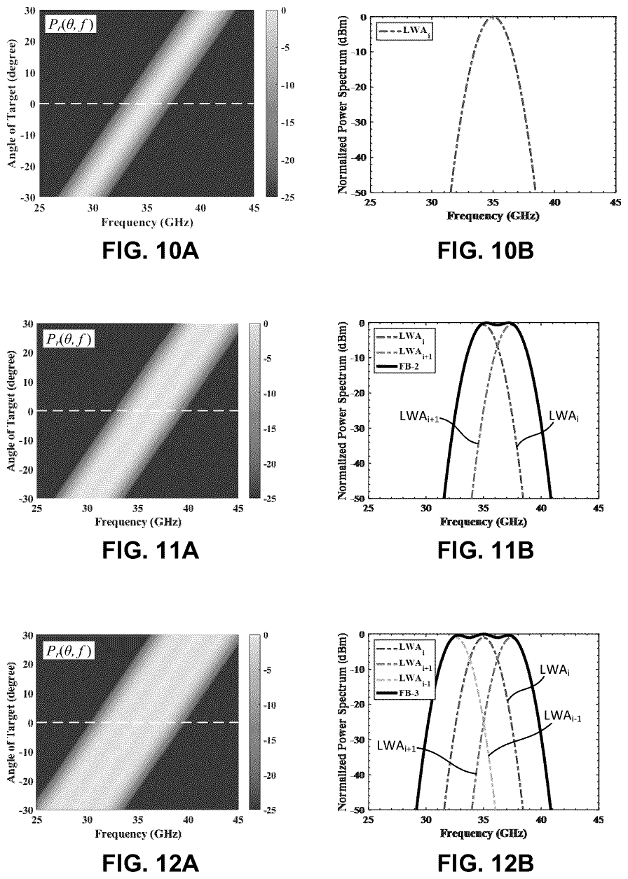

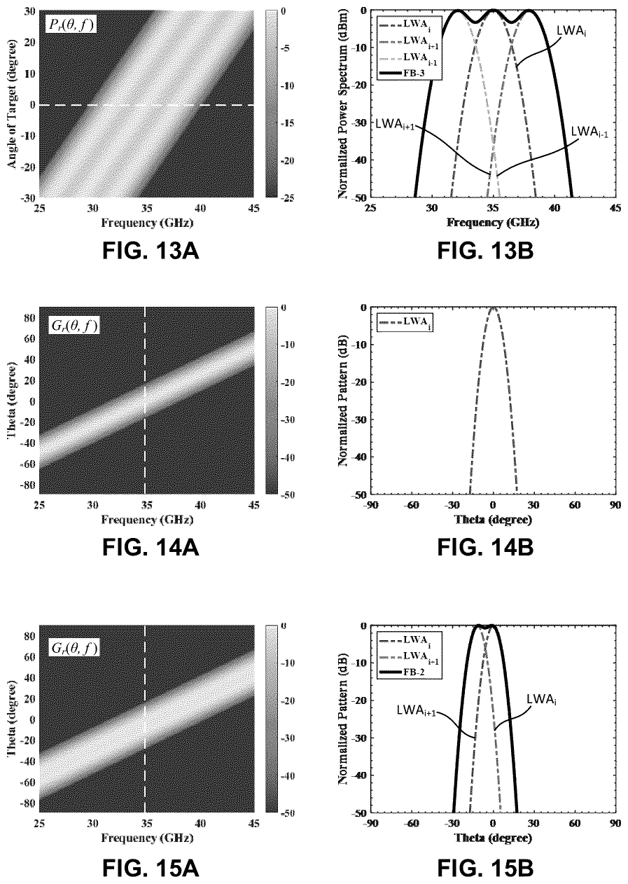

The normalized received power spectrums, when using one, two, and three Rx LWAs 142, may be simulated by calculating Equations (6) to (9) and (15), with the simulation results shown in FIGS. 10A and 10B (one LWA channel), FIGS. 11A and 11B (LWA array or filter bank (“FB-2”) of two LWA channels under 6-dB overlap criteria), and FIGS. 12A and 12B (LWA array or filter bank (“FB-3”) of three LWA channels under 6-dB overlap criteria). FIGS. 13A and 13B show the normalized received power spectrum of an LWA array or filter bank (“FB-3”) of three LWA channels under 9-dB overlap criteria.

In these figures, FIGS. 10A, 11A, 12A, and 13A show heat-maps each representing a corresponding received power spectrum with respect to different AoTs. FIGS. 10B, 11B, 12B, and 13B show the corresponding received power spectrums in a special situation that the target is in the broadside direction (that is, AoT=0).

As can be seen, the received power spectrum of one LWA exhibits a Gaussian profile that relies on the AoT due to the natural spatially-dependent filtering characteristics of the LWA. On the other hand, the LWA array using two or three LWA channels provides expanded frequency-space coverage (see FIGS. 11A and 12A), which is because, for any AoTs, the received frequency components from the LWA channels are added constructively and complementarily. The LWA array using two or three LWA channels also provides a relatively flat passband (see FIGS. 11B and 12B).

Those skilled in the art will appreciate that the filter bank related 6-dB criteria used in Equations (10) and (11) are particularly dedicated to obtaining a widened frequency spectrum with a relatively flat and smooth passband (that is, the pits or ripples in the passband are relatively small). While the 6-dB criteria may give rise to a balance between the widened spectrum and the passband flatness in some embodiments, other criteria may be alternatively used in other embodiments for achieving a wider spectrum but with larger pits or ripples in the passband.

For example, because “3-dB bandwidth” is often used for defining the useful spectrum bandwidth, in some embodiments, the “9-dB bandwidth” criteria may be used with passband ripples (see FIGS. 13A and 13B for the simulation results) much larger than those shown in FIGS. 11B and 12B (that is, the overlap frequency point between two adjacent transfer functions may be 0.354). In some other embodiments, the “9-dB bandwidth” criteria may be used (that is, the overlap frequency point between two adjacent transfer functions may be 0.354), wherein the simulation results thereof are shown in FIGS. 13A and 13B.

In the following, the 6-dB criteria will be used unless otherwise stated.

As those skilled in the art will understand, an antenna is a reciprocal component with respect to its Tx and Rx functionalities. Therefore, while the filter bank based, LWA-enabled FMCW radar system 100 and the frequency spectrum stitching methods are described above with respect to the embodiments where the LWA array is used as the Rx antenna, in some embodiments, the filter bank based, LWA-enabled FMCW radar system 100 may use an LWA array as the Tx antenna 122 and use spectrum-stitching methods similar to those described above, wherein similar principles and analyses are applicable because, for a certain frequency f, radiated signals from all those Tx LWA channels will superpose in the free-space.

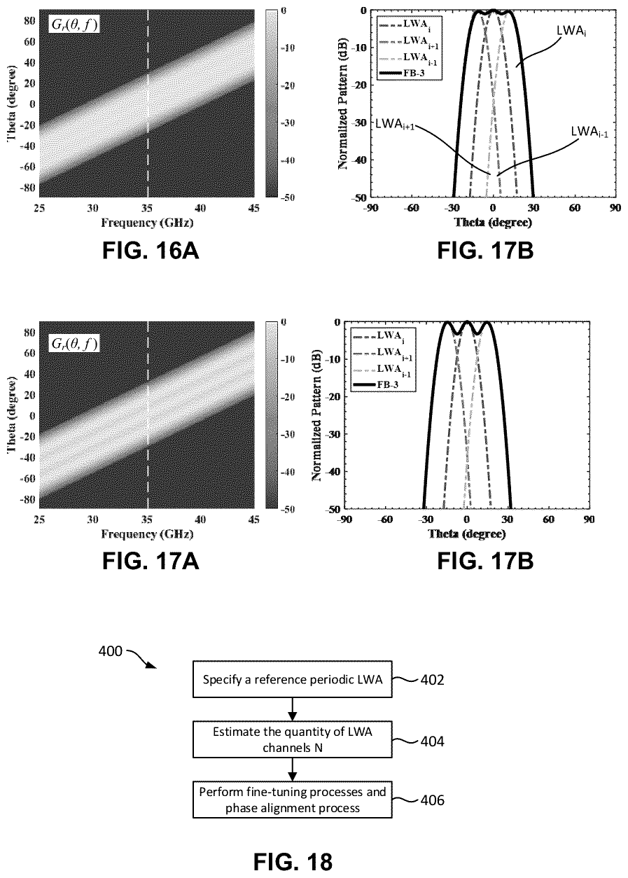

Simulation results of the normalized radiation patterns (calculated using the Friis transmission theorem), when using one, two, and three Tx LWAs 122 are shown in FIGS. 14A and 14B (one LWA channel), FIGS. 15A and 15B (LWA array or filter bank (“FB-2”) of two LWA channels under 6-dB overlap criteria), and FIGS. 16A and 16B (LWA array or filter bank (“FB-3”) of three LWA channels under 6-dB overlap criteria). FIGS. 17A and 17B show the normalized radiation patterns of an LWA array or filter bank (“FB-3”) of three LWA channels under 9-dB overlap criteria.

In these figures, FIGS. 14A, 15A, 16A, and 17A show heat-maps each representing a corresponding normalized radiation pattern with respect to different frequencies. FIGS. 14B, 15B, 16B, and 17B show the corresponding radiation patterns at the carrier frequency of 35 GHz.

As those skilled in the art will appreciate, the synthesized Tx beam with widened radiation beam-width emitted from the Tx LWA array may result in a prolonged beam dwell-time and thus enhance received spectrum bandwidth for a target. Therefore, compared to the Rx LWA array 142, Tx LWA array 122 may be more preferable and more convenient for practical implementation.

In some embodiments, the filter bank based, LWA-enabled FMCW radar system 100 may comprise a Tx LWA array 122 and an Rx LWA array 142. In some embodiments, the Tx and Rx LWA arrays 122 and 142 may comprise the same number of LWAs. In some other embodiments, the Tx and Rx LWA arrays 122 and 142 may comprise different numbers of LWAs.

### D. Implementation

According to the leaky-wave theory, an LWA may be regarded as a special guiding-while-radiating lossy transmission line (TL), where its radiation properties as an antenna may be easily predicted by its guided-wave characteristics (such as the attenuation and phase constants) as a lossy TL. For a periodic LWA using the (−1)-th order space-harmonic to radiate, its main-beam direction (or BSF θₘ) and 3-dB beam-width Δθ_{3 dB} may be expressed as

$${θ}_{m} ( f ) \approx {sin}^{- 1} ( \frac{{β}_{0} - \frac{2 π}{P}}{{k}_{0}} ) , \\ {Δθ}_{3 dB} \approx \frac{0.91}{( QP / {λ}_{0} ) cos ( {θ}_{m} ( f ) )} \qquad ( 16 )$$

where k₀ and λ₀ are the free-space wavenumber and wavelength, P and Q denote the period length and number of unit cells, respectively, β₀ refers to the phase constant of the periodic LWA's fundamental space-harmonic which also approximates the original phase constant of the unperturbed host TL. For a transverse electromagnetic (TEM) or quasi-TEM TL (for example, microstrip line) that is used for constructing a periodic LWA, the BSF in Equation (16) may be revised as

$${θ}_{m} ( f ) \approx {sin}^{- 1} ( \sqrt{{ε}_{eff}} - \frac{c}{P} \frac{1}{f} ) \qquad ( 17 )$$

where ε_{eff} is the effective relative permittivity of the host TL.

From Equation (17), a feasible approach to approximately obtain an array of N LWAs with engineered BSFs and beam-crossovers, which are required by the magnitude-stitching condition of Equation (10), is to employ a group of periodic LWAs with slightly different periods. In these embodiments, to provide an efficient design guideline and particularly to determine the period difference of those LWA channels, an LWA may be designated as a reference LWA (denoted LWAᵢ) possessing a broadside frequency of f_{bi}, a period length of Pᵢ, and a unit-cell quantity of Qᵢ. Similar to that in Subsection C, the referenced LWAᵢ is the central one among the N-channel LWA array and the subscript i is a known integer constant closest to (N+1)/2. As those skilled in the art will appreciate, at the broadside frequency f_{bi}, the period Pᵢ is equal to a guided-wavelength of LWAᵢ, and Equation (17) is equal to zero, based on which Pᵢ may be calculated from f_{bi} and ε_{eff}.

Without loss of generality, the FoV of interest is considered to be close to the broadside direction. Consequently, in the vicinity of the broadside frequency f_{bi}, the LWAᵢ's BSF may be expanded at f_{bi} using the Taylor series. Keeping the first two items of the Taylor series and neglecting higher-order ones, the BSF of LWAᵢ may be approximately expressed as

$${θ}_{m} ( f ) \approx \frac{{P}_{i} {ε}_{eff}}{c} f - \sqrt{{ε}_{eff}} \qquad ( 18 )$$

The period difference of the LWAs is generally small and the same is true for their broadside frequencies so as to obtain well-arranged BSFs and beam-crossovers. Thus, the referenced LWAᵢ's BSF θₘᵢ(f), in terms of its various-order Taylor coefficients at f_{bi}, may be approximately used to expand its adjacent LWA's BSFs 0ₘⱼ(f) at their individual broadside frequencies f_{bj}, wherein j is a dummy variable that represents the numbering of the LWAs adjacent to the referenced LWAᵢ. In this case, Equation (18) may be revised to give a generalized BSF suitable for all of the LWA channels including LWAᵢ, and is expressed as

$${θ}_{m} ( f ) \approx \frac{{P}_{i} {ε}_{eff}}{c} f - \frac{{P}_{i}}{{P}_{j}} \sqrt{{ε}_{eff}} \qquad ( 19 )$$

where Pⱼ denotes the period length of the j-th LWA (that is, LWAⱼ). When combining Equations (10) and (19) under the 6-dB design criteria, Pⱼ may be obtained as

$$\{ \begin{matrix}{P}_{j} = \frac{\sqrt{{ε}_{eff}}}{( j - i ) \sqrt{2} {Δθ}_{3 dB} + \sqrt{{ε}_{eff}}} {P}_{i} , j = i , i + 1 , i + 2 , … \\ or \\ {P}_{j} = \frac{\sqrt{{ε}_{eff}}}{\sqrt{{ε}_{eff}} - ( i - j ) \sqrt{2} {Δθ}_{3 dB}} {P}_{i} , j = i - 1 , i - 2 , …\end{matrix} \qquad ( 20 )$$

where Δθ_{3 dB} specifically refers to the 3-dB beam-width of the reference LWAᵢ at the broadside frequency f_{bi}. Those skilled in the art will appreciate that Equation (20) is an approximation for determining the initial period values of the LWAs adjacent to the reference LWAᵢ, and a fine-tune process may be performed subsequently.

With above description, FIG. 18 show a design process 400 for designing a generalized filter bank based LWA array, according to some embodiments of this disclosure.

At step 402, a reference periodic LWA with a certain broadside frequency f_{bi} (for example, a carrier frequency f_{c} of the chirp waveform in a FMCW radar system 100) and a 3-dB beam-width Δθ_{3 dB} (that is, the angle resolution Δθ required by an FMCW radar) are specified. At this step, the period length Pᵢ and the number of unit cells Qᵢ of this reference LWA may be approximately determined from Equations (16) and (17) (wherein P and Q in Equations (16) and (17) now are Pᵢ and Qᵢ). Once the reference LWA is confirmed, its beam-scanning rate Sₘ and group delay GD are also determined.

At step 404, the number of LWA channels N for implementing a filter bank may be estimated according to Equation (14) and the beam-scanning rate of the reference LWA based on the range resolution required by the FMCW radar system 100. Then, the period length of the LWAs adjacent the reference LWA may be approximately calculated according to Equation (20) as an initial value, and the numbers of their unit cells, at this stage, may be selected approximately as that of the reference LWA.

At step 406, fine-tuning processes with respect to the period length and number of unit cells of each of the LWAs adjacent the reference LWA are performed to determine the parameters of unit cells of each of the LWAs for ensuring that all filter bank related LWAs may approximately possess the designated beam-crossover and equivalent gain at the design frequency f_{c} to satisfy Equation (10), which is followed by the phase alignment process where the initial phase difference, according to (11), may be approximately calculated by considering the GD and beam-scanning rate of the reference LWA and the designated beam-crossover condition (for example, the 6-dB criteria).

In some embodiments, for a periodic LWA, a single unit-cell may be used to conveniently and accurately extract its phase constant with the aid of the Bloch-Floquet theorem. In these embodiments, it may be preferable to perform this step such that the dispersion diagram associated thereof may be used as a graphical tool to facilitate the open-stopband suppression process (for example, by using suitable matching techniques such as delay line and quarter-wavelength transformer) to ensure that these filter bank based periodic LWAs may support a continuous beam-scanning or receive signals through the broadside direction.

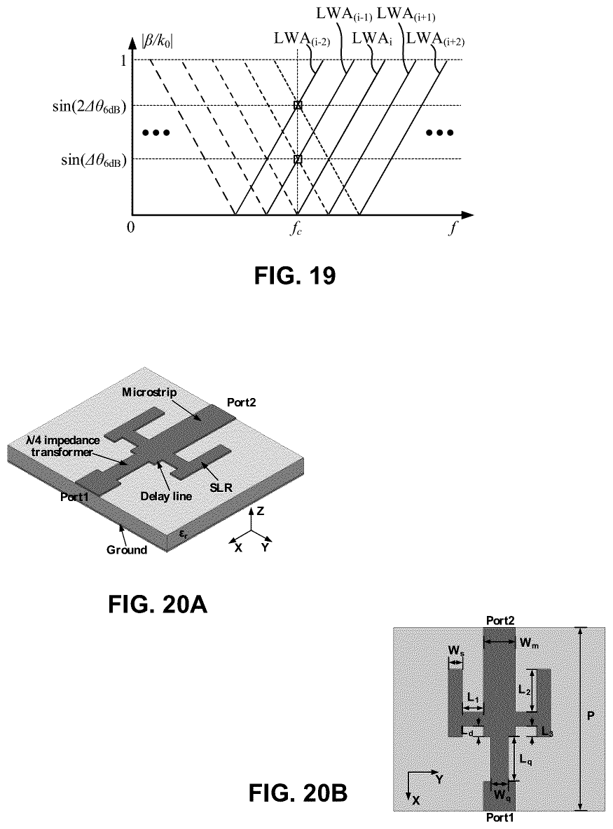

FIG. 19 is a diagram showing normalized phase constant of a filter bank based LWA array, wherein Δθ_{6 dB} refers to the 6-dB beam-width of a referenced LWAᵢ at the broadside frequency f_{c} (that is, f_{bi}), and the dashed and solid lines represent backward and forward beam-scanning regions, respectively. One may use those extracted phase constants, as conceptually illustrated in FIG. 19, to conveniently fine-tune and determine the period lengths of the LWAs adjacent the reference LWA as required by the design process 400. For example, for the referenced LWAᵢ with a broadside frequency of f_{bi}=f_{c} and the 6-dB beam-width of Δθ_{6 dB}, the normalized phase constants of its two most adjacent bilateral LWAs, namely LWA₍ᵢ₋₁₎ and LWA₍ᵢ₊₁₎, shall pass the point of [f_{c}, sin (Δθ_{6 dB})] as shown in FIG. 19. The remaining adjacent LWAs may be similarly deduced with respect to their normalized phase constants.

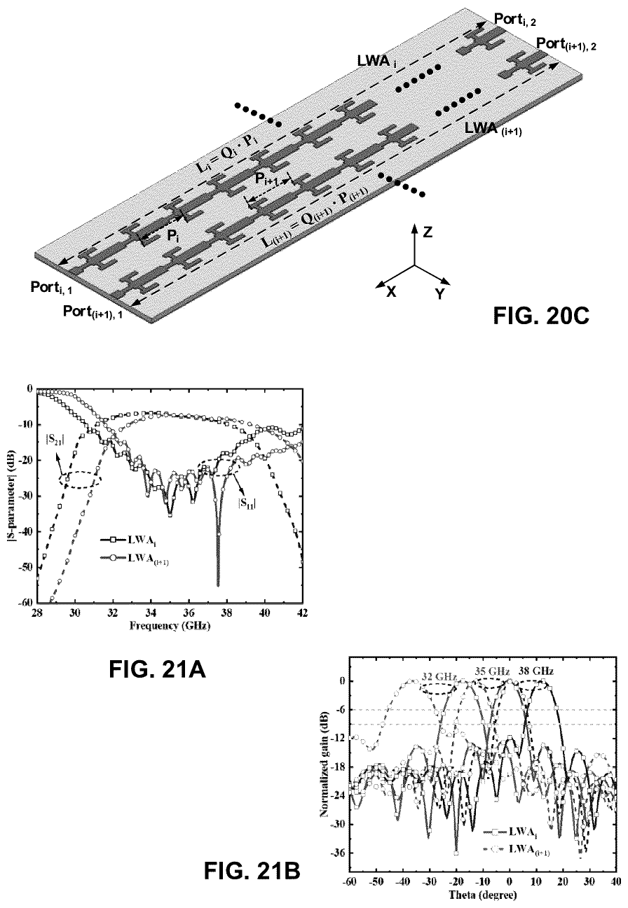

In the design process 400, it is required that all transfer functions of band-pass filters (or LWAs) should have equivalent bandwidths and maximum magnitudes, which means that the candidate LWA should embrace stable radiation performances (such as gain and beam-width) with frequency. With this consideration, multimode-resonator-related periodic LWAs may be used for fabricating the LWA array disclosed here. For example, FIGS. 20A to 20C show the LWA array designed using the design process 400 based on the stub-loaded-resonator (SLR)-based microstrip combline LWA, wherein FIGS. 20A and 20B are the perspective view and plan view, respectively, of the unit cell of the LWA array, and FIG. 20C is the perspective view of the LWA array.

In one example, an LWA array having two SLR-based LWAs, numbered as LWAᵢ and LWA₍ᵢ₊₁₎, is fabricated. The design frequency is selected as 35 GHZ, at which the first LWA (the referenced LWAᵢ) would realize the broadside radiation. The substrate in this example is Rogers RO3035 with thickness of 0.508 mm, relative permittivity of 3.6, and loss tangent of 0.0015. The period length Pᵢ of this referenced LWAᵢ may be determined as described above. Complete unit cell dimensions are Pᵢ=5.16 mm, Wₘᵢ=0.9 mm, Wₛᵢ=0.4 mm, L₁ᵢ=0.6 mm, L₂ᵢ=1.2 mm, L₃ᵢ=0.3 mm, L_{di}=0.259 mm, L_{qi}=1.185 mm, and W_{qi}=0.422 mm. In the design of this exemplary LWA array, instead of specifying the 3-dB beam-width and then calculating the number of unit cells according to the design process 400, the number of unit cells of the LWAᵢ is manually selected for convenience, such that its 3-dB beam-width may be determined accordingly and then used to calculate the period of LWA₍ᵢ₊₁₎. In this example, 10 unit-cells are cascaded to form an effective leaky-wave radiation for the LWAᵢ while the remaining power is absorbed by a matching-load termination.

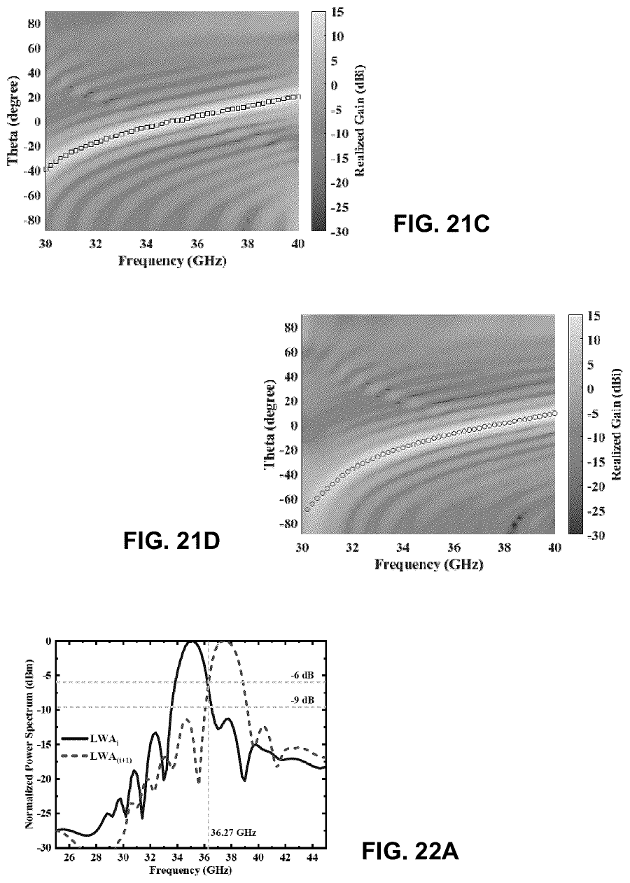

The simulated |S₁₁| and |S₂₁| of this reference LWAᵢ are shown in FIG. 21A, showing that a good impedance matching without open-stopband together with an effective radiation is realized. The normalized radiation pattern of the LWAᵢ at the design frequency of 35 GHz is plotted in FIG. 21B with the 3- and 6-dB beam-widths of 8.5° and 12°, respectively.

In this example, the 6-dB related criterion is used for a conservative design. The period length of the second LWA (that is, LWA (i+1) may be then calculated using Equation (20), which is about 4.41 mm. Subsequently, this result may be used as an initial value to adjust the geometry of LWA₍ᵢ₊₁₎'s unit cell based on FIG. 19, thereby resulting in the desirable beam-crossover and the suppression of open-stopband. After a fine-tuning process, unit cell dimensions of LWA₍ᵢ₊₁₎ are determined as P₍ᵢ₊₁₎=4.66 mm, Wₘ₍₊₁₎=0.9 mm, Wₛ₍₊₁₎=0.4 mm, L₁₍₊₁₎=0.58 mm, L₂₍₊₁₎=1.16 mm, L₃₍ᵢ₊₁₎=0.28 mm, L_{d(+1)}=0.082 mm, L_{q(i+1)}=0.934 mm, and W_{q(+1)}=0.529 mm. 11 unit-cells are cascaded to establish the LWA₍ᵢ₊₁₎ so as to realize an equivalent gain compared to that of LWAᵢ at the design frequency of 35 GHZ. The simulated scattering parameters (also called “S-parameters”) and normalized radiation patterns at 35 GHz of the LWA₍ᵢ₊₁₎ are also plotted in FIGS. 21A and 21B, respectively. Notably, the desirable 6-dB beam-crossover is realized by the two LWAs at the design frequency of 35 GHZ. Moreover, the beam-crossover of the two LWAs is sandwiched between 6- and 9-dB over the frequency range from 32-38 GHz, as also shown in FIG. 21B. This implies that a synthesized widened radiation beam may be realized and scanned with frequency (similar to FIGS. 14A to 17B), thereby facilitating obtaining an enhanced spectrum bandwidth towards certain AoTs within the FoV (similar to FIGS. 10A to 13B). The simulated 2-D realized gain patterns (versus frequency and angle) of the two LWAs, together with their BSFs, are plotted in FIGS. 21C (LWAᵢ) and 21D (LWA₍ᵢ₊₁₎. A beam-scanning rate of about 5°/GHz over the frequency region of 32-40 GHz is obtained for the two LWAs.

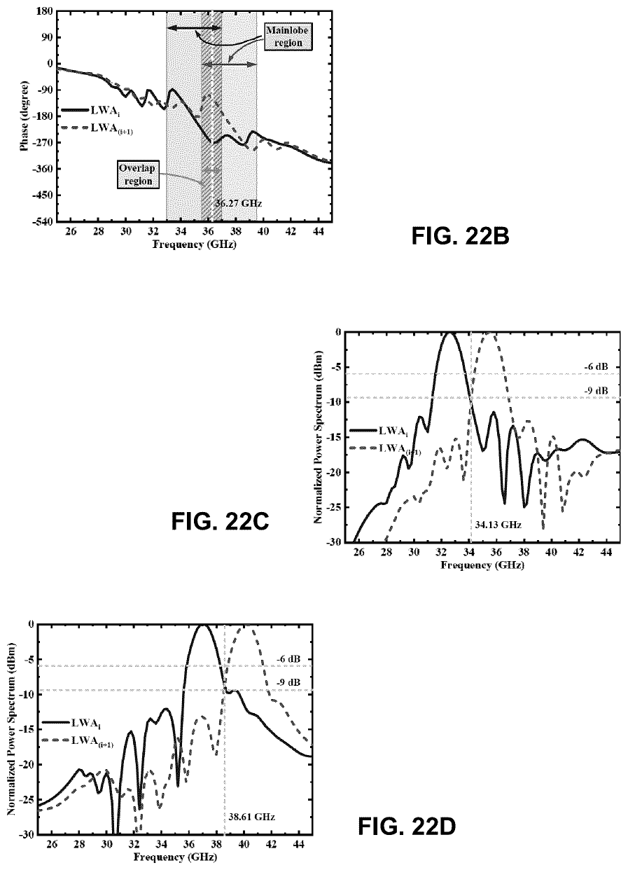

FIGS. 22A to 22D show the normalized received power spectrums of the two LWAs when they are illuminated by a wideband uniform plane-wave with the phase center (or zero-phase point) located at the antenna surface, wherein FIGS. 22A and 22B show the normalized received power spectrums and phase spectrum of the two LWAs when the incident angle of the plane-wave is 0°, and FIGS. 22C and 22D show the normalized received power spectrums of the two LWAs under the incident angles of the plane-wave of −10° and 10°, respectively. When the incident angles of the plane-wave change from −10° (backward) to 10° (forward), the center frequency and passband of the received power spectrum shows an increasing trend for each LWA, as expected.

More importantly, the two received power spectrums approximately overlap at the designated 6-dB frequency point when the incidence angle is 0°, which is consistent with FIGS. 11A and 11B, thereby manifesting the effectiveness of the developed design process 400. Also note that the spectrum crossover is still lower than 9-dB when the incident angles deviate from the broadside direction to ±10°, thereby implying that a widened spectrum with a reasonable pit or ripple may be realized within such a FoV when the two received spectrum are added coherently, which requires a phase alignment process between the two LWA channels, as described before. As shown in FIG. 22B, the received phase spectrums of the two LWAs within their overlapped main-lobe frequency region (that is, passband) possess a fixed phase difference of about Δϕ≈160°, which is similar to the situation shown in FIG. 7B. The group delay of two LWAs in their main-lobe passbands is about GD≈0.198 nanoseconds (ns), corresponding to a slope of about 71°/GHz for their phase spectrums. Considering that the reference LWAᵢ has a beam-scanning rate of about 5°/GHz and 6-dB beam-width of about 12°, the required phase difference, according to Equation (11), may be theoretically calculated as 170.4°. Both the simulated and calculated values of the phase difference are in a reasonable agreement. Such a fixed phase-spectrum difference between the two adjacent LWA channels may be compensated or calibrated out in either the digital domain by the DSP module or the RF analog domain by simply introducing a delay line on the second LWA (due to the relative narrowband property of the overlapped passband spectrum). Thus, the two output spectrums from the FB-based LWA array may be coherently superposed, thereby giving rise to a stitched frequency-space domain exhibiting an enhanced received spectrum bandwidth towards given AoTs within the FoV.

Herein, the radar system 100 collects all received signals from those FB-related LWA channels so as to realize a stitched frequency-space domain coverage for radar operations. Consider that the combination process for the received signals from those N LWA channels in cither the digital or analog domain is equivalent to the radiation pattern synthesis of an N-element antenna array in the free-space thanks to the fact that an antenna is reciprocal with respect to its Rx and Tx modes. Consequently, for a convenient demonstration and easy understanding of the filter bank enabled LWA array technique disclosed herein, the antenna's Tx mode in the form of free-space signal superposition is still selected here to facilitate design and demonstration.

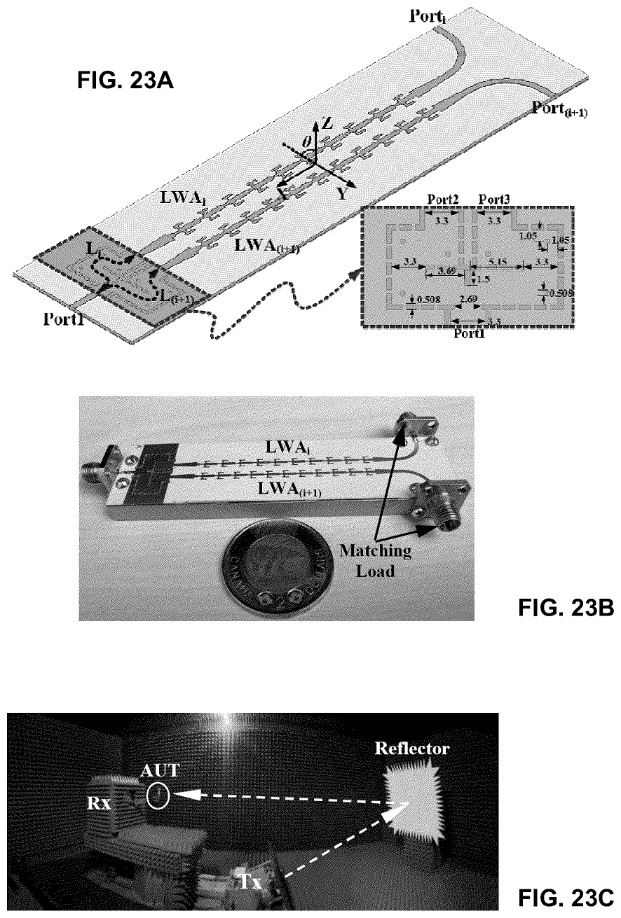

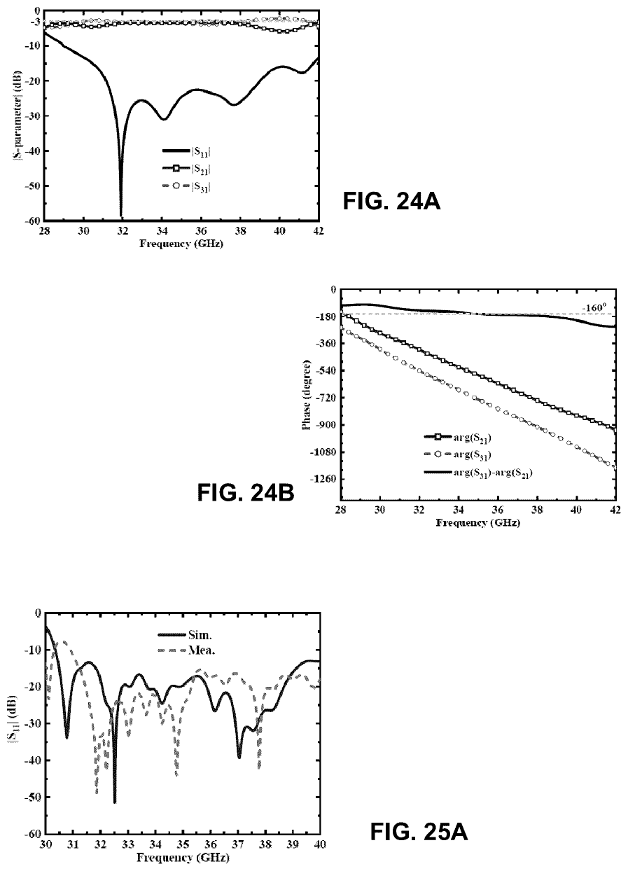

The above-described two SLR-based microstrip combline LWAs are connected to a two-way SIW power divider as shown in FIG. 23A, which may be treated as a Tx two-element LWA array. Simulated S-parameters in terms of the magnitude and phase frequency responses of the power divider are plotted in FIGS. 24A and 24B, respectively. It can be seen that the magnitude imbalance is less than 0.5 dB with the frequency range of 32-38 GHZ. To compensate for the phase difference required by the two LWA channels so that their received spectrums may be coherently stitched, the power divider's two branches are properly adjusted and optimized with respect to their path lengths (that is, Lᵢ and L₍ᵢ₊₁₎, as shown in FIG. 23A), where the initial path length difference may be easily determined according to the phase difference shown in FIG. 21A, that is, Δφ≈160°. From the perspective of the Tx functionality of an antenna, this phase compensation process between the two LWA channels is significant to ensure that the relative phases of their radiated fields in the free-space are approximately equal in the overlapped main-beam spatial region, thereby enabling their radiated fields to superpose coherently and forming a widened radiation pattern similar to FIGS. 15A and 15B.

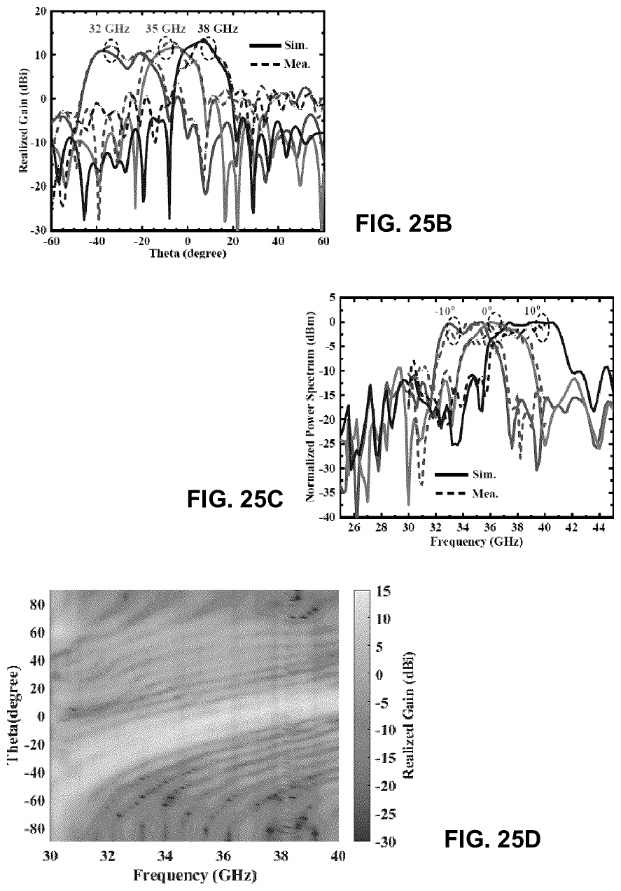

The exemplary LWA array shown in FIG. 23A comprises three ports, with the common port (Port1) fed with power while the other two (Portᵢ and Port₍ᵢ₊₁₎) terminated with matching loads. The simulated |S₁₁| of the array can be found in FIG. 25A, with a good impedance matching realized. Simulated radiation patterns at 32 GHz, 35 GHz, and 38 GHz are plotted in FIG. 25B, which clearly shows that stitched and widened radiation patterns (that is, spatial stitching process) are realized when compared to the results of two individual LWAs shown in FIG. 21B because (1) the beam-crossover between the two LWAs is kept within a reasonable level between the 6- and 9-dB conditions even though their beams are scanned with frequency, and (2) the required phase alignment process between the two LWAs has been successfully satisfied.

To test the filter bank enabled LWA array in the Rx mode, the exemplary LWA array shown in FIG. 23A is impinged by a wideband uniform plane-wave from different spatial angles, and measured results in terms of the received normalized power spectrums (which are the measured realized gain frequency responses) are shown in FIG. 25C. Clearly, the exemplary LWA array may receive and output a stitched and approximately double-wide spectrum bandwidth compared to the situations of two individual LWAs shown in FIGS. 22A to 22D and similar to the results of FIGS. 11A and 11B.

There are two aspects that need be noticed before the experimental demonstration of the proposed design concept:
(1) The measurement setup of a typical microwave anechoic chamber always comprises a Tx-Rx chain. For example, in the Compact Antenna Test Range (CATR) shown in FIG. 23C, the radiation measurement of an antenna is realized by repeatedly transmitting and receiving a wideband chirp signal against different spatial angles, which is needed for above-described experimentation.
(2) The total received power spectrum of the filter bank based LWA array is linearly proportional to the frequency response of the array's power gain. As a consequence, there is an easy and convenient approach to experimentally verify the above-described filter bank based LWA array by using the configured setup in a microwave anechoic chamber for experimentation. The measured frequency response of the realized gain at a certain angle may be used to represent the practically received power spectrum from the filter bank based LWA array.

The fabricated prototype of the filter bank based LWA array is shown in FIG. 23B. Its measured |S₁₁| and radiation patterns are plotted in FIGS. 25A and 25B, respectively. These measured results are in a reasonably good agreement with the simulations, and both demonstrate the desirable frequency-spatial stitching results. The realized gain frequency responses at several angles, which are used to represent the received power spectrums toward relevant AoTs, are plotted in FIG. 25C. Limited to the Ka-band measurement setup, only the measured results within 30-40 GHz are recorded and presented. It can be seen that the measured results of realized gain frequency responses reasonably agree with the simulated received power spectrums, thereby justifying the effectiveness of this simplified experimentation as well as the frequency-spectral stitching results. The measured 2-D realized gain pattern of the proposed array is plotted in FIG. 25D, exhibiting an obvious expanded frequency-space area when compared to FIG. 21D.

As those skilled in the art will appreciate, an Rx LWA behaves as a spatially dependent band-pass filter having different received passband spectrum towards different incident angles of wideband incoming signals. The filter bank based, LWA-enabled FMCW radar system 100 disclosed herein leverages this concept and decomposes a wideband incoming signal (such as a FMCW signal) into a plurality of sub-band signals using a bank of Rx LWAs.

After decomposition, each sub-band signal may be used for achieving an improved angle resolution in a manner similar to the single-chain LWA-based radar system. Meanwhile, all sub-band signals may be stitched or combined to enhance the received spectrum bandwidth for an improved range resolution.

Most conventional radar systems such as the conventional FMCW radar systems in current commercial radar applications mainly focus on the range resolution while the angle resolution is often secondary. On the other hand, in the FMCW radar system using a single LWA, improving the range would decrease the angle resolution. As illustrated in above description and figures, the filter bank based, LWA-enabled FMCW radar system 100 disclosed herein may provide both a high angle resolution with a good range resolution, which may be useful in applications requiring detection of objects with a high angle resolution and a moderate range resolution.

As described above, the filter bank based, LWA-enabled FMCW radar system 100 disclosed herein may realize a stitched or combined frequency-space domain for radar operations, thereby providing an enhanced applicable bandwidth spectrum to obtain an improved radar range resolution while simultaneously maintaining a good angle resolution that is enabled by the high directivity nature of LWAs. More importantly, according to Equation (14), in embodiments where the angle resolution is predetermined, a higher range resolution may be provided by using more LWA channels. Alternatively, in embodiments where the range resolution is predetermined, a higher angle resolution may be provided by using more LWA channels. Thus, the filter bank based, LWA-enabled FMCW radar system 100 disclosed herein provides more design flexibility compared to traditional radar systems.

The filter bank based, LWA-enabled FMCW radar system 100 disclosed herein simultaneously provides frequency beam-scanning and stitched frequency-space domain for radar operations. As a result, the filter bank based, LWA-enabled FMCW radar system 100 disclosed herein may provide good radar detection performances for a certain FoV coverage without the need of lossy and expensive phase-shifting components (such as phase shifters or True-Time-Delay (TTD) components) in phased-array radar systems.

In above embodiments, various radar systems are described. Those skilled in the art will appreciate that, in other embodiments, the radar systems described above may be implemented as devices, apparatuses, modules, circuitries, and/or the like as needed.

As those skilled in the art will appreciate, a “module” is a term of explanation referring to a hardware structure such as a circuitry having necessary electrical and/or optical components, circuits, logic gates, integrated circuit (IC) chips, and/or the like with suitable technologies such as electrical and/or optical technologies (and with more specific examples of semiconductors) for performing defined operations or processings.

A module may alternatively refer to the combination of a hardware structure and a software structure, wherein the hardware structure may be implemented using technologies such as electrical and/or optical technologies (and with more specific examples of semiconductors) in a general manner for performing defined operations or processings according to the software structure in the form of a set of computer-executable instructions stored in one or more non-transitory, computer-readable storage devices or media such as RAM, ROM, EEPROM, solid-state memory devices, hard disks, CDs, DVDs, flash memory devices, and/or the like. The hardware structure may comprise a processor for reading the computer-executable instructions from the storage devices and execute the computer-executable instructions to perform the defined operations or processings.

A module may be implemented as a part of a device and/or a system. Alternatively, a module itself may be implemented as a device. A module may comprise one or more submodules. Herein, a submodule is a term of explanation referring to a module of another module. Similar to a module, a submodule may be a hardware structure such as a circuitry or the combination of a hardware structure and a software structure.

As those skilled in the art will appreciate, in various embodiments, the radar systems, devices, apparatuses, modules, and circuitries described herein may be implemented as standalone systems, devices, apparatuses, modules, and circuitries, or may be implemented as part of other systems, devices, apparatuses, modules, and circuitries.

Depending on implementation and design requirements, a module as a hardware structure may be implemented as an analog module wherein the signals processed therein are analog signals (that is, continuous-time signals with unquantized or undigitized values or parameters), or a digital module wherein the signals processed therein are digital signals (that is, discrete-time signals with quantized or digitized values or parameters). Alternatively, a module may also be implemented as a combination of analog and digital components wherein ADC components are generally required to convert analog signals to digital signals, and digital-to-analog convertor (DAC) components are generally required to convert digital signals to analog signals.

For example, in the filter bank based, LWA-enabled FMCW radar system 100 shown in FIG. 6A, the front end 124 of the transmitter 102 (including the PA 116 and Tx antenna 122) may be implemented as analog components and the backend thereof (including the waveform generator 112) may be implemented as a digital component (the DAC between the backend and front end is not shown). As another example, the LWA array 142, LNAs 144, mixers 146, and LPFs 148 of the receiver 104 may be implemented as analog components and the DSP 152 is a digital component (with ADCs 150 for converting the analog signals output from the LPFs 148 to digital signals for inputting to the DSP 152.

In some embodiments, the front end 164 of the receiver 104 (including the LWA array 142 and LNAs 144) may be implemented as analog components and the front end thereof (including the mixers 146, LPFs 148 and the DSP 152) may be implemented as digital components with a plurality of ADCs 150 between the front end and backend for converting the analog signals output from the LNAs 144 to digital signals for inputting to the mixers 146.

With the rapid development of wireless technologies and increasingly crowded spectrum resource in the lower frequency bands, it is unavoidable that the working frequency of wireless systems has been continuing to move up to high frequency bands such as millimeter-wave, sub-millimeter-wave, and terahertz (THz) bands for more available spectrum resources. In radar systems, such available spectrum resources may provide desirable electrical performances such as high range resolutions. However, for a high-frequency radar system with the required beam-scanning, conventional phase-shifting devices are either unavailable or highly expensive while the full-digital radar technology may be unattractive due to its high computational complexities. Therefore, the filter bank based, LWA-enabled FMCW radar system 100 may be an effective solution for high-frequency radar front-end to provide wideband operation while simultaneously providing the required beam-scanning.

On the other hand, wireless communication systems such as 5G and 6G communication systems are also moving up to high frequency bands. In such communication systems, multiple-input multiple-output (MIMO) antenna technologies and beam-forming are often used wherein a plurality of narrow signal beams are formed for pointing towards different communication devices or users. In some embodiments, the filter bank based LWA array and beam-forming/beam-scanning methods disclosed herein may be used in MIMO communication systems to provide wideband operations to users at various spatial angles within a certain FoV, which can effectively solve the requirement of 5G communication system on the spectrum bandwidth and angular coverage. In some other embodiments, the filter bank based LWA array and beam-forming/beam-scanning methods disclosed herein may be used in various communication systems such as 6G communication systems for joint designs of wireless communications and radar sensing.

### E. Acronym Key

LWA: Leaky-Wave Antenna
FMCW: Frequency-Modulated Continuous-Wave
FoV: Field of View
FB: Filter Bank
BSF: Beam-Scanning Function
RF: Radio Frequency
CW: Continuous Wave
Tx: Transmitting
Rx: Receiving
GHz: Gigahertz
FFT: Fast Fourier Transform
TL Transmission Line
IF: Intermediate Frequency
ToF: Time of Flight
CPI: Coherent Processing Interval
AoT: Angle of Target
GD: Group Delay

Although embodiments have been described above with reference to the accompanying drawings, those of skill in the art will appreciate that variations and modifications may be made without departing from the scope thereof as defined by the appended claims.

1. A module comprising:
a transmitter (Tx) antenna; and
a receiver (Rx) antenna;
wherein at least one of the Tx and Rx antennas comprises a leaky-wave antenna (LWA) array for transmitting or receiving one or more signal beams with a range resolution and an angle resolution, the LWA array comprising a plurality of N LWAs configured as a filter bank, where N is an integer greater than 1.

2. The module of claim 1, wherein the plurality of LWAs have a same group delay; and
wherein beam-scanning functions (BSFs) of the plurality of LWAs have a same beam-scanning rate.

3. The module of claim 2, wherein each adjacent pair of LWAs of the plurality of LWAs are configured to satisfy a magnitude-stitching condition where the BSFs of the adjacent pair of LWAs are separated by the predefined angular spacing.

4. The module of claim 3, wherein the adjacent pair of LWAs have a fixed phase difference therebetween satisfying a phase-stitching condition where the phase difference therebetween is proportional to the predefined angular spacing multiplied by the group delay and divided by the beam-scanning rate.

5. The module of claim 3, wherein the predefined angular spacing is a predefined beam-width.

6. The module of claim 3, wherein the predefined angular spacing is a 6-dB beam-width or a 9-dB beam-width.

7. The module of claim 1, wherein the LWA array has a spectrum bandwidth proportional to N and a predefined angular spacing, and inversely proportional to the beam-scanning rate; or
wherein the range resolution and the angular resolution of the LWA array satisfy a condition where a production of the range resolution and the angular resolution equals to a production of the beam-scanning rate and a light speed in free space divided by 2\sqrt{2}N.

8. The module of claim 1, wherein the plurality of LWAs are based on one or more host transmission lines (TLs), or comprise a plurality of periodic LWAs with different periods.

9. The module of claim 8, wherein the one or more TLs comprises one or more waveguides, one or more substrate integrated waveguides (SIWs), and/or one or more microstrip-lines.

10. A process for fabricating a module of claim 1, the process comprising:
selecting a reference periodic LWA of the plurality of LWAs with a predefined broadside frequency f_{bi} and a 3-dB beam-width Δθ_{3 dB};
determining the number N of the plurality of LWAs for implementing the filter bank based on the range resolution; and
determining parameters of one or more unit cells of each of the plurality of LWAs for fabricating the module.

11. The process of claim 10, wherein the reference periodic LWA is an i-th LWA of the plurality of LWAs, wherein i is an integer constant that is closest to (N+1)/2.

12. The process of claim 10, wherein said selecting the reference periodic LWA comprises: using the angle resolution as the 3-dB beam-width Δθ_{3 dB}.

13. The process of claim 11, wherein the plurality of LWAs have a same group delay;
wherein beam-scanning functions (BSFs) of the plurality of LWAs have a same beam-scanning rate; and
wherein said selecting the reference periodic LWA comprises:
determining a period length Pᵢ and a number of one or more unit cells Qᵢ of the reference periodic LWAᵢ and
determining beam-scanning rate Sₘ and group delay GD of the reference periodic LWA.

14. The process of claim 13, wherein said determining the period length Pᵢ and the number of one or more unit cells Qᵢ of the reference periodic LWA comprises:
determining the period length Pᵢ and the number of one or more unit cells Qᵢ of the reference periodic LWA using:
$${θ}_{m} ( f ) \approx {sin}^{- 1} ( \frac{{β}_{0} - \frac{2 π}{{P}_{i}}}{{k}_{0}} ) , \\ {Δθ}_{3 dB} \approx \frac{0.91}{( {Q}_{i} {P}_{i} / {λ}_{0} ) cos ( {θ}_{m} )}$$
where f represents frequency, θₘ(f) is the BSF of the reference LWA, k₀ and λ₀ are free-space wavenumber and wavelength, respectively, β₀ represents a phase constant of a fundamental space-harmonic of the reference periodic LWA, and Δθ_{3 dB} represents a 3-dB beam-width of the reference periodic LWA, and using
$${θ}_{m} ( f ) \approx {sin}^{- 1} ( \sqrt{{ε}_{eff}} - \frac{c}{{P}_{i}} \frac{1}{f} )$$
where ε_{eff} is an effective relative permittivity of a host transmission line (TL) of the reference periodic LWA, and c represents a light speed in free space.

15. The process of claim 14, wherein said determining the number N of the plurality of LWAs comprises:
determining the number N of the plurality of LWAs based on the beam-scanning rate of the reference periodic LWA and the range resolution according to:
$$Δ R \cdot Δθ = \frac{c}{2 \sqrt{2} N} {S}_{m}$$
where ΔR represents the range resolution, Δθ represents the angle resolution, and Sₘ represents the beam-scanning rate.

16. The process of claim 15, wherein said determining the number N of the plurality of LWAs comprises:
determining a period length of the LWAs adjacent the reference periodic LWAᵢ and
selecting a number of unit cells of each of the LWAs adjacent the reference periodic LWA.

17. The process of claim 15, wherein said determining the period length of the LWAs adjacent the reference periodic LWA comprises:
determining a period length Pⱼ of the LWAs adjacent the reference periodic LWA according to:
$$\{ \begin{matrix}{P}_{j} = \frac{\sqrt{{ε}_{eff}}}{( j - i ) \sqrt{2} {Δθ}_{3 dB} + \sqrt{{ε}_{eff}}} {P}_{i} , j = i , i + 1 , i + 2 , … \\ or \\ {P}_{j} = \frac{\sqrt{{ε}_{eff}}}{\sqrt{{ε}_{eff}} - ( i - j ) \sqrt{2} {Δθ}_{3 dB}} {P}_{i} , j = i - 1 , i - 2 , …\end{matrix}$$

18. The process of claim 17, wherein said selecting the number of unit cells of each of the LWAs adjacent the reference periodic LWA comprises:
selecting the number of unit cells of each of the LWAs adjacent the reference periodic LWA equals to the number of unit cells of the reference periodic LWA.

19. A radar comprising the module of claim 1.

20. A communication apparatus comprising the module of claim 1.
